(19) United States
(12) Patent Application Publication
(10) Pub. No.: US 2019/0343253 A1
(43) Pub. Date: Nov. 14, 2019

(54) SERVER OR CLOUD COMPUTING DEVICE CONTROL OF SHADING DEVICES AND FLEET MANAGEMENT SOFTWARE

(71) Applicant: SHADECRAFT, INC., Pasadena, CA (US)

(72) Inventor: ARMEN GHARABEGIAN, GLENDALE, CA (US)

(73) Assignee: Shadecraft, Inc.

(21) Appl. No.: 16/409,801

(22) Filed: May 11, 2019

Related U.S. Application Data
(63) Continuation-in-part of application No. 16/008,000, filed on Jun. 13, 2018.
(60) Provisional application No. 62/670,646, filed on May 11, 2018.

(51) Int. Cl. A45B 25/16; H04W 4/80; G10L 15/26; G05B 15/02

(52) U.S. Cl. CPC A45B 25/165; G05B 15/02; G10L 15/265; H04W 4/80

(57) ABSTRACT

A computing device includes one or more memory devices, one or more processors, computer-readable instructions stored in the one or more memory devices, the computer-readable instructions being accessible from the one or more memory devices and executable by the one or more processors. The computer-readable instructions are executable by the one or more processors to 1) receive first parameters or first measurements and associated first shading device identifiers from components or assemblies of one or more first shading devices via a mobile communications device; 2) receive shading commands, instructions or messages from an artificial intelligence or voice recognition computing device; 3) communicate shading device commands, instructions or messages to one or more second shading devices via a routing computing device or a cellular computing device; and 4) receive second parameters or second measurements and associated second shading device identifiers from the routing computing device or the cellular computing device.

### RELATED APPLICATIONS

This application is related to and claims priority to U.S. provisional patent application Ser. No. 62/670,646, filed May 11, 2018, entitled “Robotic Shading Devices, Shading Devices Utilizing Artificial Intelligence, Fleet Management Of Shading Devices And IoT-Enabled Shading Devices, and U.S. non-provisional patent application Ser. No. 16/008,000, filed Jun. 13, 2018, entitled “Method and System of Fleet Management of Shading Devices, the disclosures of which are all hereby incorporated by reference.

### BACKGROUND

Umbrellas, parasols, shading systems, lighting systems and voice-activated hubs (all of which may be referred to as shading devices) may utilize arms, blades and/or a frame along with shading fabric to provide to cover individuals standing beneath or in an area covered by the shading device. However, with prior art systems, there was no way to communicate with more than one umbrellas or shading devices. In addition, there is no way to communicating with shading devices from a remote location.

### BRIEF DESCRIPTION OF THE DRAWINGS

FIG. 1A illustrates a block and dataflow diagram of communications between a shading device and/or one or more external AI or voice control servers according to embodiments;

FIG. 1B illustrates a shading device including a base assembly, a support assembly, an expansion assembly and an artificial intelligence (or AI) or voice control attachment or module according to embodiments;

FIG. 1C illustrates a voice control module or Artificial Intelligence module according to some embodiments

FIG. 2A illustrates utilizing different computing devices in different locations to control one or more shading devices according to some embodiments;

FIG. 2B illustrates data and command communication between a number of shading devices and/or computing devices according to some embodiments;

FIG. 2C illustrates distribution of music and/or audio files in a network or system including multiple shading devices according to some embodiments;

FIG. 2D illustrates additional communication paths for music distribution to shading devices according to embodiments;

FIG. 3A illustrates a method of controlling multiple shading devices through fleet management or multi-parasol control software according to embodiments;

FIG. 3B illustrates a mobile communications device (or other computing device) communicating with a plurality of shading devices according to embodiments;

FIG. 4A illustrates fleet management system operation of shading devices according to some embodiments;

FIG. 4B illustrates a shading device type selection screen according to embodiments;

FIG. 4C illustrates different ways or processes for communicating commands, instructions, messages and/or parameters to the plurality of shading devices;

FIG. 4D illustrates an input screen for an operator to create one or more shading device groups according to embodiments;

FIG. 4E illustrates another shading device control menu or web page for a selected shading device group according to embodiments;

FIG. 4F illustrates a screen of a mobile communication device operating fleet management software and receiving video or images from two or more shading devices according to embodiments;

FIG. 4G illustrates a screen of a mobile communication device operating fleet management software and receiving status measurements and/or parameters from two or more shading devices according to embodiments.

FIG. 5A illustrates a block diagram of an intelligent shading device according to embodiments;

FIG. 5B illustrates a server computing device or a cloud computing device's storage and analyzation of received parameters and measurements according to some embodiments;

FIG. 6 illustrates a shading device communicating with an IoT-enabled server or computing device according to embodiments;

FIG. 7 illustrates a smart home, smart office or smart building IoT-enabled server communicating and transferring information to a modular umbrella shading system according to embodiments; and

FIG. 8 illustrates a computing device according to embodiments.

### DETAILED DESCRIPTION

The following detailed description and provides a better understanding of the features and advantages of the subject matter described in the present disclosure in accordance with the embodiments disclosed herein. Although the detailed description includes many specific embodiments, these are provided by way of example only and should not be construed as limiting the scope of the subject matter disclosed herein.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to implementation, one embodiment, embodiments, some embodiments, and/or an embodiment means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. Similarly, a signal communicated through a motor may pass through a motor controller or other components, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

In a similar fashion, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, device or system, such as a special purpose computer or a similar special purpose electronic computing device. In the context of this specification, therefore, a special purpose computer or a similar special purpose electronic computing device may be capable of manipulating or transforming signals (electronic and/or magnetic) in memories (or components thereof), other storage devices, transmission devices sound reproduction devices, and/or display devices.

In some embodiment, a controller and/or a processor typically performs a series of instructions resulting in data manipulation. In an embodiment, a microcontroller or microprocessor may be a compact microcomputer designed to govern the operation of embedded systems in electronic devices (e.g., single board computers, and various other electronic and mechanical devices coupled thereto or installed thereon. Microcontrollers may include processors, microprocessors, and other electronic components.

In some embodiments described herein, wireless and wired communication protocols may be utilized for transmission and communications between shading devices as well as between shading devices and other computing devices. In some embodiments, shading devices may comprise one or more wireless transceivers as well as being able to be connected using wired networking protocols. In some embodiments, different communication protocols may be utilized such as cellular communication protocols, personal area network (PAN) protocols, and/or local area network protocols such as WiFi and 802.11g. In addition, ultra-low energy (ULE) or DECT protocols may be utilized to communicate between shading devices and/or between shading devices and other computing devices such as mobile communication devices and server computing devices. These communication protocols may require transceivers and transceivers may incorporate chips and/or antennas that are able to handle one or more communication protocols. In some embodiments, any of the following wired or wireless communication protocols may be utilized for communications between shading devices and/or or between shading devices and computing devices. In some embodiments, cellular communication protocols may include but are not limited to GPRS, 2G, 3G, 4G, 5G or LTE. In embodiments, other wireless communication protocols may include but are not limited to WiFi, Ethernet, WirelessHart, ISA100.11a, IEEE 802.15.4, 802.11, NFC (Near Field Communications), ANT, Bluetooth, Eddystone, Bluetooth Low Energy (BLE), ZigBee, EnOcean, WiFi, or WiMax or a combination thereof. In some embodiments, IoT-enabled protocols may also be utilized which include, but are not limited to Weightless, NB-IoT (Narrow-Band IoT), LTE-MTC (LTE-Machine Type Communication), EC-GSM-IoT (Extended Coverage-GSM-IoT), LoRaWAN, and RPMA (Random phase multiple access) communication protocols.

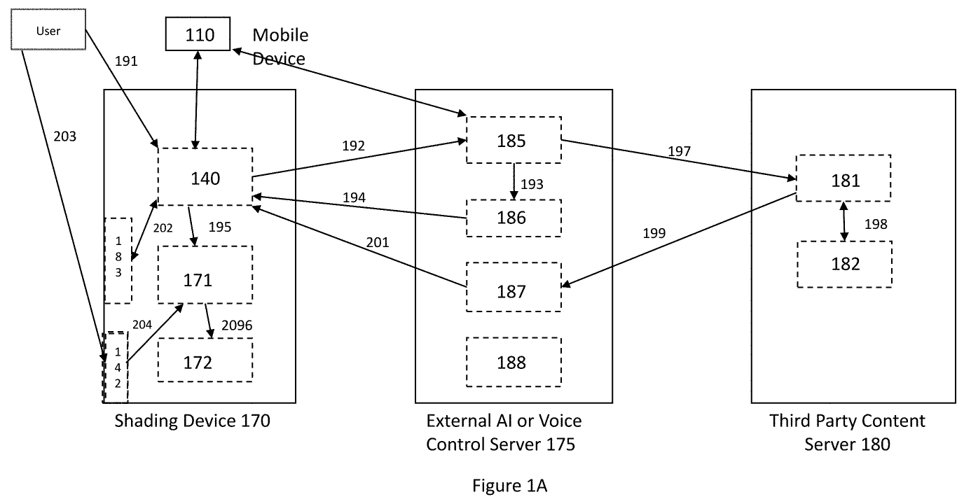

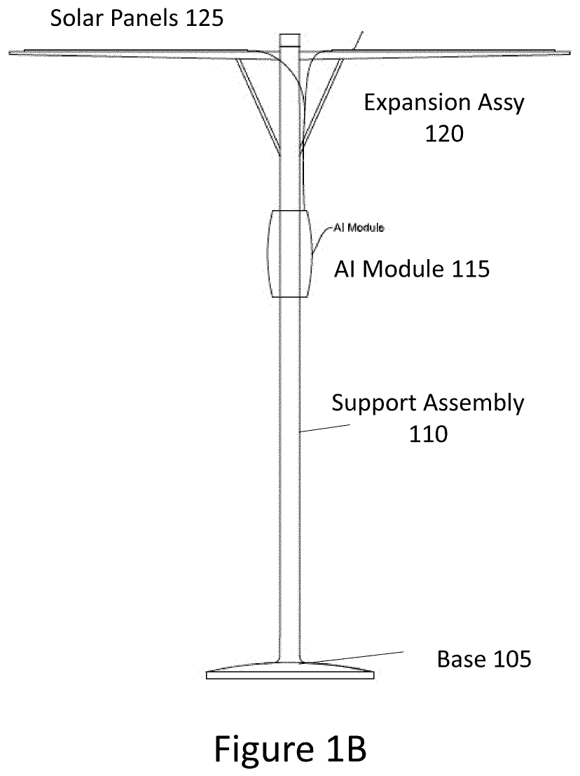

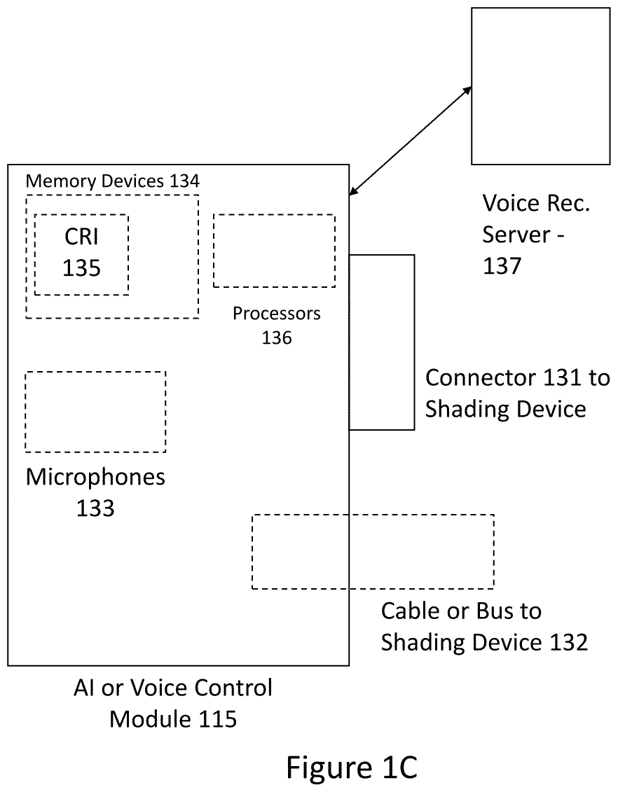

In some embodiments, a user or operator's voice may control operation of one or more shading devices. FIG. 1A illustrates operation of a voice command control of one or more shading devices according to embodiments. In some embodiments, a user standing right next to one or more shading devices may utilize voice commands to control mechanical, electrical and/or software operations of the spoken-to shading device and/or other shading devices connected to and/or grouped with the spoken-to shading device. In some embodiments, this shading device may be referred to as the master shading device. FIG. 1C illustrates a voice control module or Artificial Intelligence module 115 according to some embodiments. In some embodiments, a voice control module or an AI module 115 may be connectable to an existing umbrella and may interface with electronics and/or mechanical controllers within an existing shading device. In some embodiments, this voice control module or AI module 115 may connect, fasten, or coupled to an existing shading device housing via a fastener 131, a connector or through adhesive connection (e.g., one or more screws, a hook, velcro, an adhesive surface, nuts and bolts, wire connectors and receptacles and/or strings. In some embodiments, the separate and attachable voice control module or AI module may connect to an electrical system within the existing shading device and/or a communications bus within the existing shading device using a cable and/or a communication bus 132. In some embodiments, there may be many different AI module configurations depending on the type of shading device and what types of motor assemblies, electronic components, sensors, or devices are installed in or located within an existing umbrella or parasol. In some embodiments, a simplest design is for the AI or voice control module 115 to include one or more microphones 133 and/or associated circuitry to capture spoken commands and convert the spoken commands into audio signals and/or audio files. In some embodiments, the audio signals and/or audio files may be stored in one or more memory devices 134 of the AI or voice control module 115. In some embodiments, a simple AI or voice control module may include computer-readable instructions 135 stored in one or more memory devices 134. In some embodiments, the computer-readable instructions 135 may be executable by one or more processors 136 to transfer or communicate the generated audio files to an external computing device 137 for voice recognition and then conversion into one or more shading device commands. In some embodiments, the one or more shading device commands may then be received back from the external computing device 137. In some embodiments, the computer-readable instructions 135 executable by the one or more processors 136 may receive the shading device commands and communicate signals, commands or instructions based, at least in part on the shading device commands, to the components or assemblies in the attached or coupled shading device. In some embodiments, computer-readable instructions 135 executable by the one or more processors 136 of the AI or voice control module 115 may perform voice recognition of audio files within the AI or voice control module 115 to generate the shading device commands and then may communicate signals, commands or instructions based, at least in part on the shading device commands, to the components or assemblies in the attached or coupled shading device. In some embodiments, voice commands may also be spoken into one or more microphones in a mobile computing device. In some embodiments, the mobile computing device may receive the voice commands and convert the received voice commands into audio files. The audio files may then be communicated to either an external AI or voice control server or computing device 137 and/or to the AI module 115 as discussed above for processing. I

FIG. 1A illustrates a block and dataflow diagram of communications between a shading device and/or one or more external AI or voice control servers according to embodiments. In some embodiments, voice control servers 175 may refer to servers that perform voice recognition on received voice command files and may also refer to servers that generate commands, instructions, messages and/or signals based at least in part on converted voice command files and then communicate the generated commands, instructions, messages and/or signal to the one or more shading devices. In some embodiments, a shading device 170 may communicate with an external AI or voice control server 175 and/or additional content servers 180 via wireless and/or wired communications networks using PAN, WiFi, 802.11g, Wireless LAN, Ethernet, Firewire or cellular communication protocols, as described in detail above and below.

In some embodiments, a user or operator may speak 191 a command (e.g., “turn on lights,” “rotate shading device,” “activate shading device sun tracking,” “open shading device,” “activate playing of music on Group A shading devices”) which may be captured by one or more microphones and may be converted into an audio file. In some embodiments, an artificial intelligence or voice control application programming interface (API) 140 may communicate and/or transfer 192 an audio file (utilizing a transceiver—one or more PAN, WiFi/802.11, or cellular transceivers or transceivers described above) to an external or third-party AI or voice control server 175. In embodiments, an external AI or voice control server 175 may be a cloud-based server. In embodiments, an external AI or voice control server 175 may receive audio files, recognize the audio files utilizing voice recognition and convert the audio files to shading device commands, instructions, and/or messages that are received by the shading device and instruct the shading device to perform certain actions and/or operations. In some embodiments, an external AI or voice control server 175 may comprise a voice recognition engine or module 185, a command engine module 186, a third party content interface 187 and/or third party content formatter module 188. In some embodiments, an external AI or voice control server 175 may receive 192 one or more audio files and a voice recognition engine or module 185 may convert received audio file(s) to a device command (e.g., shading system commands, computing device commands) and communicate 193 the device commands to a command engine module or engine 186. In some embodiments, if a voice command is for operation of a shading devices 170, a command engine or module 186 may communicate and/or transfer 194 a generated command, message, and/or instruction to one or more shading devices 170. In other words, the AI or voice-control server may perform speech recognition of the received audio file (e.g., the user or operator's spoken commend) and convert this to a shading device command, message, and/or instruction. Also, if the voice command was for multiple shading devices, (e.g., “turn on lights on Group B devices,”) the external AI or voice control server 175 may communicate the commands, instructions and/or messages to the multiple corresponding shading devices.

In some embodiments, as illustrated in FIG. 1A, a shading device 170 may receive the communicated command, communicate and/or message and transfer 195 the communicated command to one or more controllers or processors 171 in the shading device. In embodiments, the one or more controllers or processors 171 may generate 196 a command, message, signal and/or instruction to cause an assembly, component, system or devices 172 in the shading device to perform an action requested in the original voice command (“turn on lights,” “rotate shading device,” “activate shading device sun tracking,” “open shading device,” “activate playing of music on Group A shading devices”). In some embodiments, the communications between the shading device(s) or devices may occur utilizing wired or wireless communication transceivers or via communication buses in the shading device 170.

In embodiments, a user or operator may request actions to be performed utilizing a shading system's microphones and/or transceivers that may require interfacing with third party content servers (e.g., interfacing with a home security system such as RING or NEST, interfacing with an e-commerce site selling sun care products, interfacing with an e-commerce site selling parts of umbrellas or shading devices, communicating with online digital music stores or application servers (e.g., iTunes, Pandora, Spotify), communicating with weather servers and/or communicating with traffic servers). For example, in some embodiments, a shading device user may request 1) traffic conditions from a third-party traffic server; 2) playing of a playlist from a user's digital music store or application accounts; 3) ordering a replacement skin and/or spokes/blades/arms for a shading device. In these embodiments, additional elements and steps may be added to previously described method and/or process of FIG. 1.

For example, in some embodiments, a user may speak 191 a command or desired action (execute playlist, order replacement spokes/blades, and/or obtain traffic conditions from a traffic server) which is captured as an audio file and received at an AI or voice control API 140 stored in one or more memory devices of a shading device 170. As discussed above, in some embodiments, an AI or voice control API 140 may communicate and/or transfer 192 an audio file utilizing one or more of the shading device's transceiver to an external AI or voice control server 175. In embodiments, an external AI or voice control server 175 may receive one or more audio files and a voice recognition engine or module 185 may recognize and convert 193 received audio files to a query request (e.g., a traffic condition request, an e-commerce order, a request to retrieve and stream a digital music playlist).

In some embodiments, an external AI or voice control server may communicate and/or transfer 197 a query request to a third party content server (e.g., traffic conditions server (e.g., SIGALERT or Maze server), an e-commerce server (e.g., a RITE-AID or SHADECRAFT server, or an Apple iTunes server) to obtain third party goods and/or services. In embodiments, a third-party content server 180 (e.g., a communication and query engine or module 181) may retrieve 198 requested services from a database 182 in the third-party content server in response to a request. In some embodiments, a third-party content server 180 may communicate services queried by the user (e.g., traffic conditions or digital music files to be streamed) 199 to an external AI or voice control server 175. In embodiments, a third-party content server 180 may order requested goods for a user and then retrieve and communicate 199 a transaction status to an external AI or voice control server 175. In some embodiments, a content communication module 187 may receive communicated services (e.g., traffic conditions or streamed digital music files) or transaction status updates (e.g., e-commerce receipts) and may communicate 201 the requested services (e.g., traffic conditions or streamed digital music files) or the transaction status updates to one or more shading devices 170. In some embodiments, computer-readable instructions located in one or more shading devices may be executable by one or more processors to convert received traffic services information and convert the traffic services information into an audio signal, transfer the audio signal including traffic conditions to an audio signal, which reproduces the audio signal on an audio speaker or system 183. In some embodiments, digital music files may be communicated and/or streamed directly to an audio system 183 because there is no conversion necessary. In some embodiments, E-commerce receipts may be converted and communicated to speaker 183 in an audio system for audible reproduction. In some embodiments, e-commerce receipts may also be transferred to one or more computing devices in a shading device 170 for storage in one or more memory devices.

In some embodiments, computer-readable instructions in one or more memory devices of a shading devices may be executed by one or more processors and may comprise a voice recognition module or engine 142. In this illustrative embodiment, voice recognition may be performed at a shading device 100 without utilizing a cloud-based AI or voice control server. In embodiments, a shading device 170 may receive 203 the communicated voice command, convert the one or more shading voice commands to device commands, instructions and/or messages and communicate and/or transfer 204 the communicated device commands to one or more controllers/processors 171 in the shading device. In some embodiments, the one or more controllers/processors 171 may generate and/or communicate 196 a command, message, signal and/or instruction to cause an assembly, component, system or device 172 to perform an action or operation requested in the original voice command. While FIG. 1A illustrates a voice recognition module or engine 142 in the shading device, this may also refer to an add-on AI module or voice control module that may be added to a shading device as described above.

In some embodiments, referring back to FIG. 1A, a mobile computing device 110 may communicate with a shading system with artificial intelligence or voice control capabilities. In embodiments, a user may communicate with a mobile computing or communications device 110 by speaking a verbal command into one or more microphones. In some embodiments, a mobile computing or communications device 110 may communicate a digital or analog audio file to one or more processors 127 and/or an AI or voice control API 140 in a shading device housing. In some embodiments, a mobile computing or communications device 110 may also convert the audio file into a textual file for easier conversion at the external AI or voice control server 150. In some embodiments, a mobile computing or communications device 110 may also perform voice recognition utilizing computer-readable instructions executable by the one or more processors of the mobile computing device, may then convert the recognized voice files to device commands and may communicate device commands, instructions and/or messages to one or more shading devices to cause the one or more shading devices to perform actions based on the received commands. In some embodiments, a mobile computing or communications device 110 may also transfer captured audio files (based on the voice commands received via the one or microphones of the mobile computing or communications device 110) directly to an external AI or voice control server 175. In this illustrative embodiment, the external AI or voice control server 175, may recognize the commands in the received audio files and convert the recognized commands to shading device commands, instructions and/or messages and communicate the shading device commands, instructions and/or messages to the mobile computing and communications device, which may communicate the shading device commands, instructions and/or messages to the one or more shading devices 170. As discussed above, the mobile communications and computing device 110 may control one or more multiple shading devices 170 utilizing voice commands.

In some embodiments, a shading device having a shading element, a shading frame and/or shade fabric, a shading support, a shading housing and/or a shading base. In some embodiments, a shading housing such as the one described above may be attached to any shading system and may provide artificial intelligence functionality and services. In some embodiments, a shading system may be an autonomous and/or automated shading system having an integrated computing device, sensors and other components and/or assemblies, and may have artificial intelligence functionality and services provided utilizing an AI or voice control API stored in a memory of a shading housing.

In some embodiments, FIG. 1B illustrates a shading device including a base assembly, a support assembly, an expansion assembly and an artificial intelligence (or AI) or voice control attachment or module according to embodiments. In some embodiments, the AI or voice control attachment or module may allow existing shading devices to be able to operated utilizing voice commands. In embodiments, a shading device may comprise solar panels 125, an expansion assembly 120 including arms, a support assembly 110, a base 105 and/or an AI or voice control module 115. Although a simple shading device is illustrated in FIG. 1B, where only one motor may be utilized to open and close the arms of the shading device 100, an AI or voice control module 115 may also be connected to more complex umbrellas, such as umbrellas that tilt or have an elevation motor, and/or rotate about a vertical axis or in an azimuth direction. In embodiments, an AI or voice control module 115 may also be connected to a lighting system and/or building shading systems (e.g., awnings). In some embodiments, an AI or voice control module 115 may be attached to a support assembly 110 via fasteners, connectors, couplers or adhesives or a combination thereof. In embodiments, an AI or voice control module 115 may be small than shown in FIG. 1B and may also be located on a base assembly, an expansion assembly. In embodiments, an AI or voice control module 115 may be self-powered, e.g., via rechargeable batteries or via solar panels or cells attached to an outside surface of the AI module. In some embodiments, a power bus or cable of the shading device 100 may be connected to the AI or voice control module 115 so that the solar panels 125 on the shading device 100 may provide power to the AI or voice control module 115. In some embodiments, the AI or voice control module 115 may comprise one or more microphones to capture voice commands spoken by users and/or operators. In embodiments, the AI voice or control module 115 may comprise one or more controllers and/or processors. In some embodiments, the AI or voice control module 115 may comprise computer-readable instructions that are stored in one or more memory devices and that are executable by the one or more processors or controllers to take the capture voice commands and convert into audio files. In some embodiments, the one or more processors may comprise computer-readable instructions that are executable by the one or more processors to communicate the captured audio files utilizing one or more wireless transceivers. In some embodiments, the AI or voice control module 115 may comprise one or more wireless transceivers (e.g., PAN transceivers, WiFi or Wireless LAN transceivers and/or cellular transceivers or transceivers described above) to communicate captured audio files with external AI or voice control servers 175, as shown in FIG. 1A. In some embodiments, the AI voice control attachment or module 115 may be able to be connected to an existing power bus in an umbrella. In embodiments, the AI voice control attachment or module 115 may be able to be connected and/or attached to an existing communications bus within a shading device and be able to communicate with existing components, assemblies and/or devices utilizing the already existing communication bus. For example, a communication bus may be a serial communications bus and the AI voice control attachment or module 115 may be able to connect with that communications bus and transmit commands, instructions, messages, signals and/or data to existing components and/or assemblies. For example, if an existing umbrella has one motor to open and close the shading device, which is driven by a motor controller that receives commands or signals from a switch, for example, the AI voice control attachment or module 115 may attach to the communication bus and communicate device commands to the motor controller In order to open and close the shading device. In some embodiments, the AI voice control attachment or module may communicate with more intelligent or complex motor controllers and/or systems by connecting and/or tapping into the existing communications bus. Similarly, if a lighting system is activated by a button or in response to a light sensor determining there is not enough light, an AI voice control attachment or module 115 may connect with a lighting controller and/or directly to cables or wires going directly the lighting assembly itself to provide the necessary commands, instructions, messages or signals to the lighting assembly based, at least in part on the received voice commands. Similarly, the AI voice control attachment or module 115 may also stream music to an existing audio system within the existing shading device. If the existing shading device has an audio system, but no Bluetooth or PAN transceiver capabilities, the AI voice control attachment or module 115 may utilize one of its transceivers to receive music (e.g., from an external online music server) and convert the music to audio files that may be reproduced on the existing audio system of the existing shading device. In embodiments, the AI voice control attachment or module 115 may be connected to a communications bus that is connected to the existing audio system or may be connected directly to the existing audio system. In some embodiments, an AI voice control attachment or module 115 may perform voice recognition on the captured audio files, if there is enough memory for the software voice recognition engine or module to be stored within the AI voice control attachment or module 115. In this illustrative embodiment, the software or combination software and hardware may perform voice recognition to identify the spoken commands and command files and then convert the recognized commands files into device commands, instructions, messages and/or signals. In some embodiments, in order to allow the AI voice control attachment or module to interface with existing systems, there may be interface ports or connectors (e.g., serial communication connectors or other communication connectors) to allow cables and/or wires to be connected to existing communication buses or systems. Please note that computer-readable instructions stored in memory devices and executable by one or more processors may be referring to software code, code embedded in hardware or other integrated circuits, system-on-chip processors such as a Libre processor, and other existing software and/or hardware combinations. In some embodiments, the AI voice control attachment or module 115 may receive audio files from a mobile computing device or another computing device and either perform voice recognition and shading device command generation within the AI voice control attachment or module 115 (e.g., a voice recognition engine stored within memory devices of the AI voice control module 115) or may communicate the received audio files to an external, remote or cloud-based voice control module or AI module to perform voice recognition and/or shading device command generation and then receive back the shading device commands, instructions and/or messages.

Robotics/Artificial Intelligence/Deep Learning—Prior shading devices such as umbrella and parasols have not incorporated robotics. Prior shading devices may have had switches or similar devices to respond to a signal from a sensor, e.g., a wind sensor sends a signal, and an umbrella may close. However, no umbrellas have robotics which provides a shading device with a capability of operating autonomously, and or in response to commands from a mobile communication device, from a desktop or laptop computing device, a wearable computing device and even from an IoT-enable computing device. This is in addition to being able to be controlled by voice, as is discussed above with respect to FIGS. 1A and 1B. In some embodiments, shading device may respond to complicated and multi-step commands generated by software stored in one or more memory devices of the shading device and executable by one or more processors of the computing device and perform these actions autonomously.

For example, robotics may be utilized during a setup, configuration and/or restart operation of a shading device. In some embodiments, a robotic shading device, when powering up or being rebooted may determine a position of the sun with respect to the shading device based on execution of software instructions and inputs regarding time, date and/or geographical location. In some embodiments, for example, in response to determination of the sun or light source, software instructions executable by one or more processors of the shading device may generate a series of commands, instructions, messages and/or signals to the different motor controllers integrated within the shading device to move the shading device to a desired rotation location about a vertical or azimuth axis, a desired elevation angle to block an operator or user from the sun or light source and/or an a desired expansion distance or position (either full open deployment or full retraction. This is far more complicated and/or computing different from a switch or a sensor sending a signal and an umbrella responding from closing an umbrella. It is also more detail that other references provide as to exactly how the shading device may work. In some embodiments, computer-readable instructions executable by the one or more processors may continue to monitor a sun or light source position periodically during the day or may generate a series of commands, instructions, messages and/or signals to the different motor controllers integrated within the shading device to update positioning of different assemblies within the shading device to continue providing shade for the user or operator and continue to track the sun. In some embodiments, in addition to the parameters discussed above, the shading device may also canvas environmental sensors integrated within the shading device to determine if shading is necessary or if environmental conditions identify that it may not be safe to operate the shading device. In some embodiments, for example, if a rain sensor or lightning sensor identifies that it is raining or that lightning is within an area around the shading devices, the computer-readable instructions executable by the one or more processors of the shading device may cease operation of assemblies of the shading device.

In addition, as another example, a shading device may also employ robotics and/or artificial intelligence to deal with environmental situations. In some embodiments, a shading device may be operational and being utilized to provide shade to an operator or user. In some embodiments, computer-readable instructions executable by one or more processors of a shading device may communicate commands, instructions, signals and/or messages to one or more sensors to determine environmental conditions in the area surrounding the shading device and/or a group of shading devices. In some embodiments, for example, the one or more sensors may be one or more temperature sensors, humidity sensors, light sensors, ultraviolet (UV) radiation sensors, air quality sensors, carbon monoxide sensors, carbon dioxide sensors, wind sensors, digital barometers, lightning sensors or a combination thereof. In some embodiments, computer-readable instructions executable by one or more processors of a shading device may receive the sensor measurements and/or parameters, analyze the received sensor measurements and/or parameters and determine a course of action for the shading device as to further operations. In some embodiments, these operations may include, but not be limited to closing a shading device, moving a shading device, turning off a shading device, activating or deactivating wireless communications of a shading device, or activating or deactivating sensors, cameras or audio systems of a shading device. In some embodiments, the computer-readable instructions executable by the one or more processors of the computing device may generate commands, instructions, messages or signals to have these operations performed simultaneously, sequentially and/or at periodic times. In some embodiments, the shading device is utilizing artificial intelligence to determine desired operations of the shading device and robotics to cause the shading device to perform the desired operations. No other shading device appears to include the features and/or functionality to perform these operations and no other shading devices appear to utilize artificial intelligence to make determinations as to what operations to perform.

In addition, as another example, a shading device may also employ robotics and/or artificial intelligence to address malfunctioning operations and/or monitoring shading device operations. In some embodiments, it is important to keep track of performance and operation of one or more shading devices, especially in hospitality environments where it is important that all shading devices are operation. In some embodiments, computer-readable instructions executable by one or more processors of the integrated computing device may communicate with assemblies, components, systems or devices within the shading device to determine whether the assemblies, components, systems or devices are operating properly or malfunctioning. In some embodiments, computer-readable instructions executable by one or more processors may receive operational parameters or measurements, analyze the received operational parameters or measurements, determine whether the assemblies, components, systems or devices are operating properly and communicating operational status of the assemblies, components, systems and/or devices to external computing devices (e.g., mobile computing devices, wearable computing devices, desktop computing devices, server computing devices) and/or systems within the one or more shading devices (e.g., audio systems, lighting systems and/or the integrated computing device). In some embodiments, this may allow users to perform maintenance on their own shading device and/or hospitality providers to identify which shading devices may need to be replaced and/or repaired.

In addition, as another example, a shading device may also employ robotics and/or artificial intelligence and/or deep learning to move automatically based on user's history or user preferences. In some embodiments, computer-readable instructions executable by one or more processors of the shading device may canvas one or more sensors, devices, components and/or assemblies of the shading device, capture status information, positioning measurements and/or orientation measurements of the sensors, devices, components and/or assemblies as well as time or date information and may store the status information, positioning measurements, orientation measurements, time measurements and date measurements in one or more memory devices of the shading device, a mobile communications device communicating with one or more shading devices and/or a remote computing device (e.g., cloud-based server, database server, and/or application server). In some embodiments, at different dates and times, computer-readable instructions executable by the one or more processors of the shading device or a mobile computing device may retrieve the measurements, analyze the measurements and either make a recommendation to activate certain sensors, devices (e.g., cameras or lights) and/or components and/or move assemblies of the shading devices to associated positions based on the current time and/or the historical data. In other words, the shading device software is utilizing artificial intelligence to determine a current position of the shading device based at least in part on historical behavior and positioning of the shading device.

In addition, as another example, a shading device may also employ robotics, and/or artificial intelligence and/or deep learning to move and adjust itself with respect to preprogrammed routines. In some embodiments, a user or operator may be able to establish routines for one or more shading devices. As discussed above, the preprogrammed routines may be based on historical behavior, activations, positioning or orientation of the one or more shading devices. As discussed above, the preprogrammed routines may be communicated from a mobile computing device and/or external computing devices to the shading device and stored in one or more memory devices of the shading device. In some embodiments, the mobile computing device and/or external computing device may communicate preprogrammed routines to the one or more shading devices when operations are to be performed. In some embodiments, the preprogrammed routines may be executed at specified times and/or dates. In some embodiments, a time and/or clock may communicate that a preprogrammed routine should begin to be executed and the computer-readable instructions executable by one or more processors of the shading device may begin to execute the preprogrammed routine and initiate communication of commands, instructions, messages and/or signals to components, assemblies, sensors or devices within the shading device. Again, this is the use of software to perform a complicated string of instructions and utilize robotics to perform these tasks, which is not being done by other shading devices.

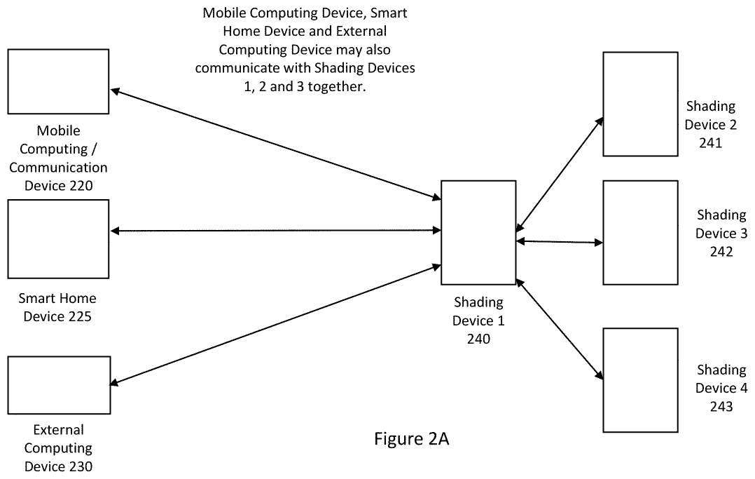

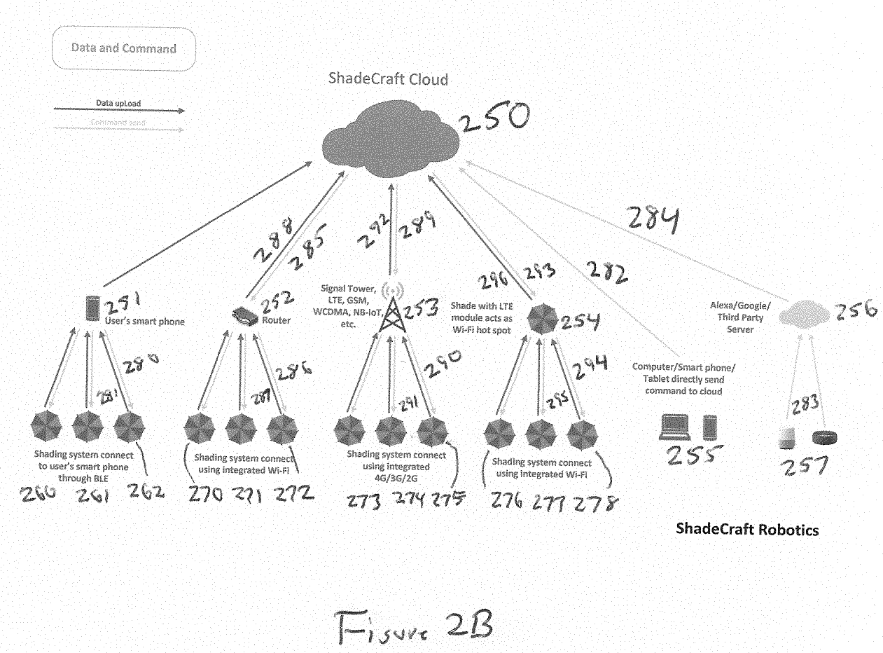

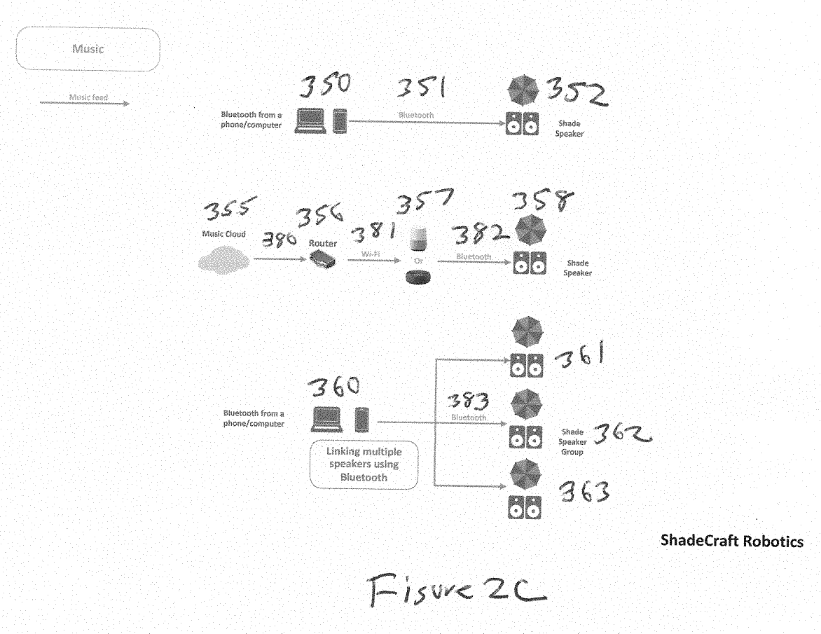

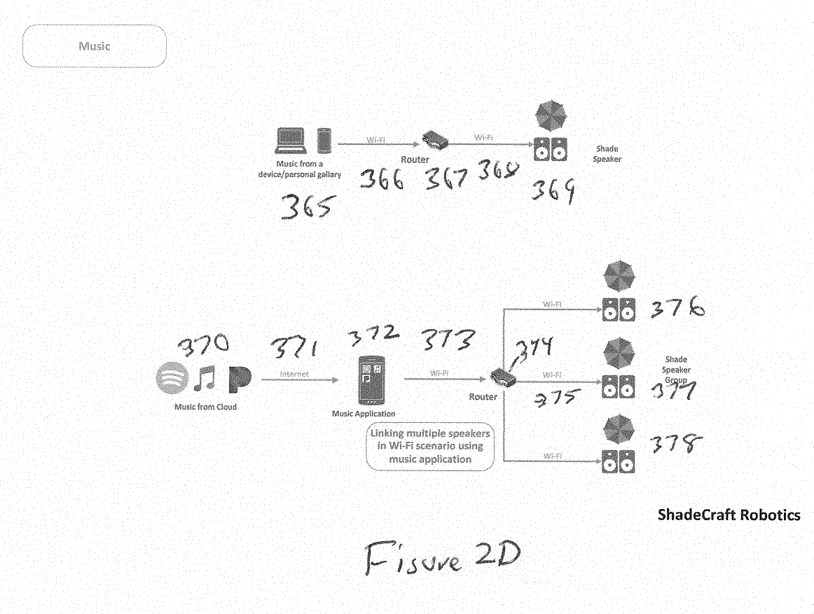

FIG. 2A illustrates utilizing different computing devices in different locations to control one or more shading devices according to some embodiments. In some embodiments, a shading device 201 may operate autonomously based on computer-readable instructions executable by one or more processors in the shading device. In some embodiments, each of the individual shading devices 240 241 242 and 243 may operate autonomously in this fashion. In embodiments, one shading device may be a master shading device and the other shading devices may be responding shading devices where the master shading device may control the operations and/or actions of the other shading devices. In some embodiments, a mobile communications device (e.g., smartphone, laptop, wearable computing device, mobile phone, tablet) 220 may control operations of one or more shading devices 240 241 242 243 through execution of software on the mobile communications device 220 (and/or server device) and communicating commands, instructions, signals or messages to the one or more shading devices 240 241 242 243. In embodiments, the mobile communications device 220 may communicate with all or a portion of the shading devices 240 241 242 243 individually or may communicate with one of the shading devices 240 which in turn may relay the commands, instructions, messages and/or signals to the other shading devices 242 243 241. In embodiments, a smart home device 225 (e.g., a console, an operation panel, and/or a tablet supplied by a smart home provider) may communicate commands, instructions, signals or messages to one or more shading devices 240 241 242 243 to control operations of the one or more shading devices. In some embodiments, smart home device 225 may communicate with all or a portion of the shading devices 240 241 242 243 individually or may communicate with one of the shading devices 240 which in turn may relay the commands, instructions, messages and/or signals to the other shading devices 242 243 241. In embodiments, other external computing devices 230 may also communicate commands, instructions, signals or messages to one or more shading devices 240 241 242 243 to control operations of the one or more shading devices. In some embodiments, users or operators may logon to existing systems that have SmartShade APIs or software applications installed thereon and then communicate with the one or more shading devices. Further, in embodiments, users or operators may login into a SmartShade URL and identify shading devices to be controlled and may communicate instructions, commands, signals and/or messages to the one or more shading devices over a global communications network (e.g., the Internet). In embodiments, other external computing devices 230 (e.g., server computing devices or other remote computing devices) may communicate with all or a portion of the shading devices 240 241 242 243 individually or may communicate with one of the shading devices 240 which in turn may relay the commands, instructions, messages and/or signals to the other shading devices 242 243 241.

FIG. 2B illustrates data and command communication between a number of shading devices and/or computing devices according to some embodiments. In some embodiments, local or remote computing devices and/or shading devices may receive performance measurements and/or parameters, status indicators or parameters, audio and/or video, and/or environmental or directional parameters, measurements, data and/or information from the shading device and display such within the shading device application software on the mobile communication device. In some embodiments, the activities of the multiple shading devices that may be controlled may be: 1) the expanding or opening and the closing of the arms or blades of the shading device; 2) the rotating of the shading device about an azimuth axis and/or about a base assembly; and/or the 3) the tilting of a portion of the shading device with respect to another portion of the shading device (e.g., changing in an elevation such as rotating an upper portion of the support assembly with respect to a lower portion of the support assembly). In embodiments, the activities of the multiple shading devices that may be controlled may be a calibration of a direction of the shading device; setting of a date and/or time for the shading device; setting sun rise time for automatic operation (e.g., opening or adjusting a shading device); setting sun set time for automatic operation (e.g., closing or adjusting a shading device for sunset); setting up and/or selecting a wireless transceiver (e.g., cellular, WiFi or personal area network—Bluetooth or BLE); activating and/or deactivating one or more sensor assemblies; receiving measurements, parameters, data and/or information from environmental sensors and/or directional sensors. In some embodiments, the activities of the shading devices that may be controlled may include update weather conditions or settings for the shading device (e.g., wind sensor sensitivity, temperature and/or humidity sensitivities). In some embodiments, the activities of the shading devices that may be controlled may be the operation and/or activation of one or more cameras and/or audio systems in the shading devices. In embodiments, the activities of the multiple shading devices that may be controlled may also include: 1) adjusting an intensity and/or activation/deactivation of a lighting assembly; 2) pausing and/or playing music or digital music files and/or transferring or streaming of music, audio or video files; 3) controlling volume settings for reproducing sounds; 4) turning on and/or off the camera and/or adjusting camera settings; and/or 5) adjusting a wind sensor or other environmental sensor or directional sensor sensitivity.

In some embodiments, the multiple shading devices (or each shading device) may communicate some of the following parameters, measurements, data and/or information to the local or remote computing devices and/or other shading devices). In some embodiments, the parameters, measurements, data, and/or information may be 1) open and/or close status of assemblies or components; 2) operational status or indicators (including error conditions or other codes) for electro-mechanical assemblies or components of the shading devices; 3) directional parameters, measurements, data or and/or information from directional sensors; 4) angular parameters, measurements, data and/or information from gyroscopes, accelerometers or other similar devices; 5) GPS location parameters, measurement and/or information; 6) obstacle detection parameters, measurements, and/or information; 7) presence or motion detection parameters, measurements, and/or information; 8) battery health, percentage left or expended, and/or battery temperature; and/or 9) performance of solar panels and/or solar charging assembly. In some embodiments, the parameters, measurements, data and/or information may also be 1) environmental conditions (e.g., temperature readings, humidity readings, air quality readings, carbon monoxide readings, carbon dioxide readings) from environmental sensors; 2) wind speed measurement, parameters and/or information from wind sensors; 3) ambient light measurements, parameters, and/or information from light sensors; 4) ultraviolet sensor measurements, parameters and/or information from UV sensors; 5) rain sensor parameters, measurements, and/or information from rain sensors; and/or 6) lightning sensor parameters, measurements, and/or information from lightning sensors.

In some embodiments, FIG. 2B illustrates SHADECRAFT cloud server(s) or server computing devices 250, one or more mobile communication device 251, one or more routers or router computing devices 252, one or more wireless communication tower computing devices 253, one or more shading devices utilized as a wireless communication hub 254, one or more user computing devices (e.g., laptops, desktops, and/or tablets) 255 and/or one or more third party AI or voice recognition server computing devices 256. Although reference number 250 is referred to as cloud servers or cloud computing devices, the server computing devices may be located in facilities or areas that are not part of the cloud. In some embodiments, FIG. 2B also illustrates grouping of shading devices according to some embodiments. FIG. 2B illustrates the many different ways that status indicators, status parameters, measurements, parameters, information and/or data from one or more shading devices may be uploaded into cloud computing devices or server computing devices 250 for storage, aggregation and/or analysis. In some embodiments, shading device identifiers and/or location parameters associated with the shading device status indicators, status parameters, measurements, parameters, information and/or data may also be uploaded or communicated to the cloud computing devices or server computing devices 250. No other shading system or computing system utilizes umbrellas or shading devices in the same way that Shadecraft shading devices do. In some embodiments, for example, a shading device mobile application (e.g., SMARTSHADE) running on a mobile communications device (e.g., smart phone 251) may communicate with one or more shading devices 260 261 and/or 262 in order to gather measurements, parameters, information, and/or data (as well as status indicators or parameters) from the shading devices 260 261 and/or 262. In some embodiments, the mobile communications device 251 may communicate commands, messages and/or instructions to the one or more shading 260 261 and/or 262 as is illustrated by reference numbers 280 to request that components, assemblies or parts of the shading devices 260 261 and/or 262 perform certain actions, collect certain measurements, parameters, information and/or data and/or provide status indicators or parameters. In some embodiments, the one or more shading devices 260 261 and/or 262 may perform the requested actions and/or collect the measurements, parameters and/or data (as well as status indicators or parameters) and may communicate this back to the mobile communications device 251 (e.g., the mobile software application in the mobile communications device 251) status of the performed actions and the collected measurements, parameters and/or data (as well as status indicators or parameters), as is illustrated by reference number 281 in FIG. 2A). This is an advantage over other shading systems which do not communicate back status parameters and/or measurements to a mobile computing device or software application (e.g., other shading systems do not have bidirectional communications). In some embodiments, the bidirectional communications between the mobile communications device 251 and the one or more shading devices 260 261 and 262 may occur utilizing a Bluetooth Low Energy (BLE) wireless communication protocol. In some embodiments, other personal area network (PAN) wireless communication protocols may be utilized for the bidirectional communications between the mobile communications device 251 and/or the one or more shading devices 260 261 and/or 262. In some embodiments, the mobile communications device 251 may communicate the received status parameters or indicators and/or the received measurements, parameters, information and/or data to the one or more cloud (or remote) computing devices or server computing devices 250. In some embodiments, the one or more cloud computing devices 250 may be referred to as “the Shadecraft Cloud” as is illustrated in FIG. 2B (although any remote storage devices or databases may be utilized to house this information).

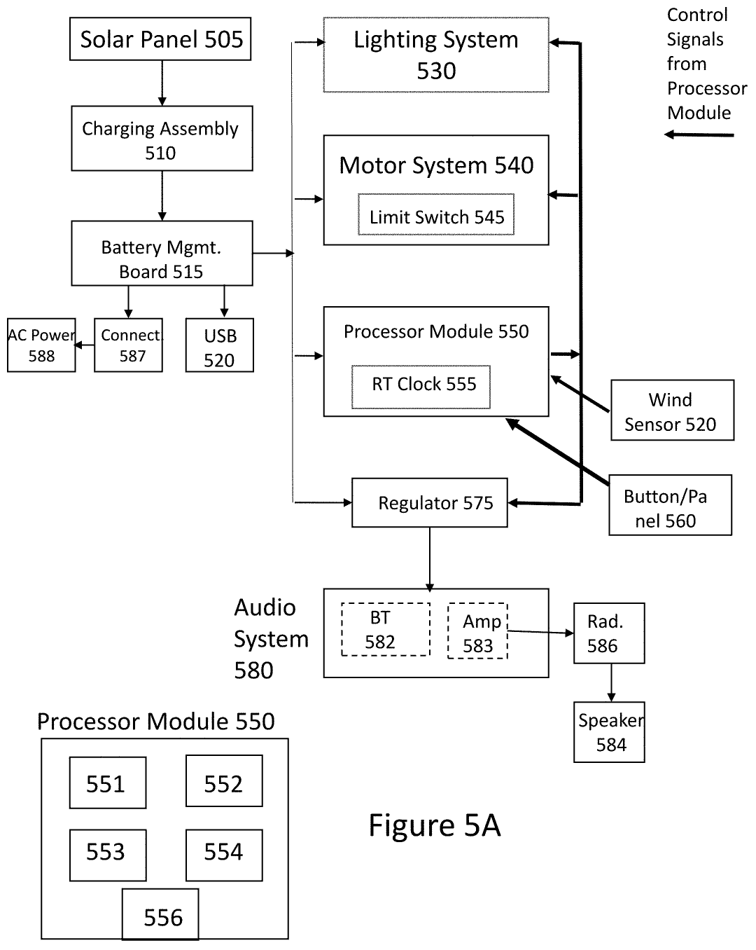

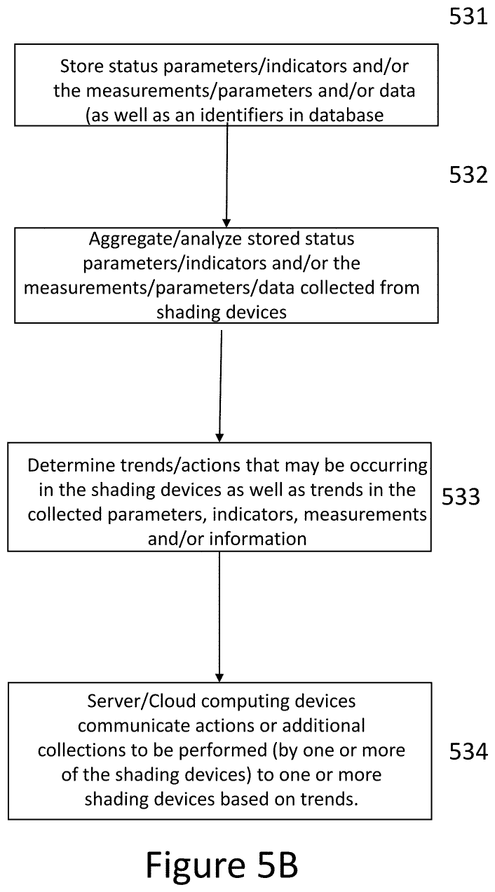

FIG. 5B illustrates a server computing device or a cloud computing device's storage and analyzation of received parameters and measurements according to some embodiments. In some embodiments, the one or more cloud computing devices 250 may receive the communicated and/or collected status parameters or indicators and/or the received measurements, parameters, information and/or data and may store 531, in a database, the status parameters or indicators and/or the measurements, parameters and/or data (as well as an identifier of geographic location of the shading device and/or the shading device from which the status parameters or indicators (as well as measurements, parameters, and/or data is collected). This is different from other methods of communications because the mobile computing device or other computing devices described herein do not have to first communicate with the one or more cloud computing devices in order to communicate with the shading devices. There is direct bidirectional communication between the shading devices 260 261 and/or 262 and the mobile communications device 251. In some embodiments, computer-readable instructions executable by one or more processors on the one or more cloud computing devices or server computing devices 250 may retrieve (from the database the stored parameters, indicators, and measurements, and aggregate and/or analyze 532 the stored status parameters or indicators and/or the measurements, parameters and/or data that were collected from the one or more shading devices 260, 261 and/or 262. In some embodiments, computer-readable instructions executable by one or more processors on the one or more cloud computing devices or server computing devices 250 may analyze the collected parameters, measurements, and/or indicators to determine 533 trends and/or actions that may be occurring in the shading devices and/or within the area where the shading devices are located as well as trends in the collected parameters, indicators, measurements and/or information. In some embodiments, this may be analyzing the collected parameters, measurements and/or indicators and determining that motor assemblies of multiple shading devices are experiencing the same error or malfunction; that wind sensors in multiple shading devices are capturing measurements indicating dangerous wind conditions, that cameras are capturing images of objects during times in which no objects or individuals should be present, and/or that specific batteries are not being charged to the same level although similar energy is being captured by the solar panels of the one or more shading devices. The examples above are not limiting in any fashion and status indicators, status parameters, measurements, parameters and/or data collected from any component or assembly of shading devices may be collected and analyzed to determine trends. In some embodiments, the computer-readable instructions executable by the one or more processors on the one or more server computing devices and/or clouding computing devices may communicate actions or additional collections to be performed 534 (by one or more of the shading devices) to one or more shading devices based, at least in part, on the trends observed or detected by the received status parameters, status indicators, data, measurements and/or information. In some embodiments, these actions and/or additional collections may be communicated directly to the one or more shading devices and/or indirectly through a mobile communications device, a routing computing device, a cellular computing device, and/or another shading device (e.g., such as a master shading device).

In some embodiments, external devices may be utilized to communicate with one or more shading devices. In some embodiments, the external computing devices may be user computing devices (e.g., such as a laptop computing device, a mobile communication device, and/or a tablet computing device) 255 and/or third-party computing, AI or voice recognition computing devices 257 (e.g., Amazon Echo or Alexa and/or Google) that utilize voice recognition to receive and/or transfer voice commands to perform certain actions. In some embodiments, the user computing devices 255 may communicate with the one or more cloud computing devices 250 via a client-server software application, a cloud-based software application and may communicate commands, messages or instructions (which are meant for remote shading devices) to the one or more cloud computing devices 250. In some embodiments, this is represented by reference number 282. This is a direct interface without having to go to third-party computing devices. In some embodiments, users or operators of the one or more user computing devices 255 may need to have an account (or login information) on the server computing devices and/or the cloud computing devices. In some embodiments, computer-readable instructions executable by one or more processors on the server computing devices and/or cloud computing devices 250 may interpret the received commands (e.g., if necessary) and may communicate the received commands, messages or instructions to remote shading devices through a variety of means which are discussed in detail above and below. In some embodiments, for example, the one or more cloud computing devices or server computing devices 250 may communicate the commands, messages and/or instructions received from the user computing devices 255 to one or more shading devices via one or more mobile communications devices 251, one or more routers or routing computing devices 252, one or more cellular towers and/or cellular computing devices 253, or other shading devices (e.g., a master or alpha shading device 254). In response to the commands originally sent from the user computing devices 255, the one or more shading devices may communicate status indicators, status parameters, measurements, parameters and/or data from the shading device components, assemblies or sections back through the mobile communications device 251, one or more router or routing computing device 252, one or more cellular towers and/or cellular computing devices 253, or other shading devices (e.g., a master shading device 254) to the one or more cloud computing devices or server computing devices 250 for storage, aggregation, and/or analysis.

In some embodiments, a user or operator may speak voice commands (that are meant for one or more shading devices) to a third-party artificial intelligence, home automation and/or voice recognition device 257 (an Amazon Dot or Echo or a Google Home device). In some embodiments, the third-party AI, home automation and/or voice recognition device 257 may capture the spoken commands and convert these spoken commands to audio files. In some embodiments, the third-party AI, home automation and/or voice recognition device 257 may communicate and/or transfer the one or more audio files to the third-party computing device or server 256 (e.g., an Alexa/Google/third party server). This communication may be illustrated by reference number 283. In some embodiments, computer-readable instructions executable by one or more processors on the third-party computing device or server (e.g., an Alexa or Google voice recognition server) 256 may interpret or analyze the received audio file and determine that the received audio file corresponds to one or more shading device commands, messages and/or instructions. In some embodiments, the third-party computing device and/or server 256 may communicate the shading device commands, messages and/or instructions to the one or more cloud computing devices or server computing devices 250 (e.g., the communication path is illustrated by reference number 284). In some embodiments, computer-readable instructions executable by one or more processors on the cloud computing devices 250 may communicate the received commands, messages or instructions (which are received from the third party computing devices or servers 256) to remote shading devices through a variety of means which are discussed in detail above and below. In some embodiments, for example, the one or more cloud computing devices 250 may communicate the commands, messages and/or instructions received from the third party AI or voice recognition computing devices or servers 256 (and from the third-party AI computing devices 257) to one or more shading devices via one or more mobile communications devices 251, one or more router or routing computing devices 252, one or more cellular towers and/or cellular computing devices 253, or other shading devices (e.g., a master shading device 254). In some embodiments, in response to the commands originally sent from the third-party AI, home automation and/or voice recognition device 257, the one or more shading devices may communicate status indicators, status parameters, measurements, parameters, information and/or data from the shading device components, assemblies or sections back through the one or more mobile communications devices 251, the one or more router or routing computing devices 252, one or more cellular towers and/or cellular computing devices 253, or other shading devices (e.g., shading device 254) to the one or more cloud computing devices or server computing devices 250 for storage, aggregation, and/or analysis.

In some embodiments, one of the paths the user computing devices 255 or the third-party AI, home automation or voice recognition devices 257 may utilize to communicate with shading devices may be to utilize one or more wireless LAN routers or routing computing devices 252, which may operate according to WiFi or other 802.11 wireless communication protocols. In this illustrative embodiment, the one or more cloud computing devices 250 may communicate commands, messages and/or instructions to one or more routers or router computing devices 252, the path being illustrated by reference number 285. In some embodiments, the one or more routers or router computing devices 252 may communicate with one or more shading devices 270, 271 and/or 272 utilizing WiFi or other 802.11 wireless communication protocols, as illustrated by reference number 286. In some embodiments, the one or more shading devices 270, 271 and/or 272 may communicate collected status indicators, status parameters, measurements, parameters, information and/or data collected from components, assemblies and/or sections of the one or more shading devices 270, 271, and/or 272 to the one or more routers or routing computing devices 252 (as illustrated by communication path 287). In this illustrative embodiment, the wireless routers or router computing devices 252 may communicate the received status indicators, status parameters, measurements, parameters, information and/or data to the one or more cloud computing devices 250 for storage, aggregation and/or analysis. In some embodiments, the communication paths may operate utilizing WiFi, wireless LAN or other 802.11 wireless communication protocols.

In some embodiments, one of the paths the user computing devices 255 or the third-party AI, home automation or voice recognition devices 257 may utilize to communicate with shading devices may be to utilize cellular tower or cellular computing devices 253, which may be LTE, GSM, WCDMA, NB-IoT compatible devices which operate according to 2G, 3G, 4G and/or 5G standards (or protocols). In some embodiments, although the specification may refer to cellular tower or cellular computing devices, this may refer to the computing devices (and associated components) that allow data to be transferred via cellular networks. In this illustrative embodiment, the one or more cloud computing devices 250 may communicate commands, messages and/or instructions to one or more cellular tower or cellular computing devices 253, the communication path being illustrated by reference number 289. In some embodiments, the one or more cellular tower or cellular computing devices 253 may communicate with one or more shading devices 273, 274 and/or 275 utilizing 2G, 3G, 4G or 5G wireless communication protocols, as illustrated by reference number 290 (identifying the communication path). In some embodiments, the one or more shading devices 273, 274 and/or 275 may communicate status indicators, status parameters, measurements, parameters and/or data collected from components, assemblies and/or sections of the one or more shading devices 273, 274, and/or 275 to the one or more cellular tower or cellular computing devices 253 (as illustrated by communication path 291). In this illustrative embodiment, the one or more cellular tower or cellular computing devices 253 may communicate the received status indicators, status parameters, measurements, parameters and/or data to the one or more cloud computing devices 250 for storage, aggregation and/or analysis, as illustrated by reference number and/or communication path 292.

In some embodiments, one or more shading devices may act as a wireless communication hub or may act as a master shading device. In these embodiments, the shading device (e.g., master shading device 254) may become the communications hub for one or more other shading devices 276, 277 and/or 278. In some embodiments, one of the paths the user computing devices 255 or the third-party AI, home automation or voice recognition devices 257 may utilize to communicate with shading devices may be the master shading device or shading device communications hub 254. In some embodiments, the master shading device or shading device communications hub 254 may communicate with the one or more other shading devices 276, 277 or 278 utilizing a cellular wireless transceiver (e.g., using LTE, GSM, WCDMA, NB-IoT transceivers which operate according to 2G, 3G, 4G and/or 5G standards (or protocols)) or may communicate with the one or more shading devices 276, 277 or 278 via a WiFi or another 802.11 wireless communication transceiver. In this illustrative embodiment, the one or more cloud computing devices 250 may communicate commands, messages and/or instructions to one or more master shading devices or shading device communication hubs 254, the communication path being illustrated by reference number 293. In some embodiments, the one or more master shading devices or shading device communication hubs 254 may communicate with one or more shading devices 276, 277 and/or 278 utilizing 2G, 3G, 4G or 5G wireless communication protocols or via WiFi (or other 802.11) wireless communication protocols, as illustrated by reference number and communication path 294. In some embodiments, the one or more shading devices 276, 277 or 278 may communicate status indicators, status parameters, measurements, parameters and/or data collected from components, assemblies and/or sections of the one or more shading devices 276, 277 or 278 to the one or more master shading devices or shading device communication hubs 254 (as illustrated by communication path 295). In this illustrative embodiment, the one or more master shading devices or shading device communication hubs 254 may communicate the received status indicators, status parameters, measurements, parameters and/or data to the one or more cloud computing devices 250 for storage, aggregation and/or analysis, as illustrated by reference number or communication hub 296. In some embodiments, the commands, messages and/or instructions may request that one or more shading devices to perform certain actions; activate certain components or assemblies, capture measurements and/or parameters, communicate audio and/or video to external devices, and/or to transfer audio to shading devices to be played.

FIG. 2C illustrates distribution of music and/or audio files in a network or system including multiple shading devices according to some embodiments. In some embodiments, a computing device or a mobile communications device 350 (e.g., a laptop computing device, a desktop computing device, a tablet computing device, and/or a mobile communications device) may transfer music files (or audio files) to a shading device 352 (e.g., an audio system and speakers in the shading device) utilizing Bluetooth (or other personal area network—PAN) wireless communication protocols (as illustrated by music communication path 351). Although audio and music files are described herein, the same principles may be applied to transferring video files. In some embodiments, the music file or audio files may be stored on the computing device or the mobile communications device 350. In some embodiments, music files and/or audio files may be stored on music cloud computing devices 355 (e.g., a Pandora server, a Spotify server, or an iTunes server). In some embodiments, the music files and/or audio files may be transferred to the one or more shading devices 358. In some embodiments, music files and/or audio files may be requested from a user utilizing a mobile communications device software application. In some embodiments, the music files and/or audio files may be transferred or communicated to one or more wireless routers or router computing devices 356 utilizing music communication path 380. In some embodiments, the music files or audio files may be communicated or transferred to one or more AI, home automation or voice recognition computing devices 357 utilizing WiFi, 802.11 or other wireless LAN communication protocols or methodologies (as is illustrated by music communication path 381). For example, the AI, home automation or voice recognition computing devices 35y may be Amazon Echo and/or Google Now computing devices. In some embodiments, the music files and/or other audio files may be transferred from the one or more AI, home automation or voice recognition computing devices 357 to one or more shading devices 358 (and speaker assemblies) utilizing Bluetooth (or other personal area network) wireless communication protocol or methodologies, which is illustrated by music communication path 382. In some embodiments, a computing device or a mobile communications device 360 may link to one or more audio systems and/or speakers in associated one or more shading devices 361 362 and/or 363 utilizing Bluetooth (or other personal area network) wireless communication protocol or methodologies, which is illustrated by music communication path 383.

FIG. 2D illustrates additional communication paths for music distribution to shading devices according to embodiments. In some embodiments, music files and/or digital audio files may be stored in one or more memory devices in a computing device and/or a mobile communications device 365. In some embodiments, this may be referred to a personal gallery of music. In some embodiments, the music files and/or digital audio files may be communicated from the computing device or mobile communications device 365 to a routing device or a routing computing device 367 via communication path 366 (which may be a WiFi, wireless LAN or other IEEE 802.11 compatible communication path). In some embodiments, the routing device or routing computing device 367 may communicate the received music files and/or digital audio files to the one or more shading devices 369 (e.g., the audio systems and/or one or more speaker assemblies) for playback or reproduction. In some embodiments, the communication path 368 between the one or more routing computing devices or router 367 and the one or more shading devices 369 may be a WiFi, wireless LAN or other IEEE 802.11 compatible or compliant communication path.

In some embodiments, the one or more audio files or music files may be stored in cloud computing devices (e.g., an iTunes music server computing device, a Spotify music server computing device and/or a Pandora music server computing device) and may be transferred and/or communicated to a music software application on a mobile communication device 372 via a global communications network (or Internet) 371. In some embodiments, the music software application on the mobile communication device 372 may communicate the music files and/or audio files to multiple shading devices (e.g., shading devices 376, 377 or 378). In order to accomplish this, the music software application on the mobile communication device 372 may communicate the music files and/or audio files to one or more routing devices or routing computing devices 374 via a WiFi, wireless LAN or other 802.11 communication path 373. In some embodiments, the one or more routers or routing computing devices 374 may transfer the audio files and/or music files to one or more shading devices 376, 377, 378 via a WiFi, wireless LAN or other 802.11 wireless communication path 375.

FIG. 5A illustrates a block diagram of an intelligent shading device according to embodiments. In embodiments, an intelligent shading device 500 may comprise one or more solar panel arrays 505, one or more solar power chargers 510, one or more battery management assembly 515 and/or one or more USB connectors 520. In embodiments, one or more solar panel arrays 505 may convert solar energy into high voltage DC power. In embodiments, the one or more solar power arrays or cells 505 may be coupled to the one or more solar power chargers or charging assemblies 510. In embodiments, the one or more solar power chargers 510 may be a maximum power point tracker (MPPT) may be an electronic DC to DC converter that optimizes an interface and/or connection between one or more solar panel arrays 505 (e.g., PV panels), and a battery management assembly 515 (including a battery bank). In embodiments, one or more solar power chargers 510 may convert a higher voltage DC output from one or more solar panel arrays 505 down to a lower voltage needed to charge one or more batteries in a battery management assembly 515. In embodiments, one or more batteries in a battery management assembly 515 may be rechargeable batteries and may be LiPo batteries. In embodiments, a battery management assembly 515 may also include a battery holder and/or battery management circuitry (e.g., a printed circuit board, integrated circuits, etc.) to manage the power transfer and/or distribution from the one or more solar power chargers 510 to the batteries in the battery management assembly 515. In embodiments, a battery holder may comprise 1 to 4 holders that each include up to 4 rechargeable batteries. In embodiments, a battery management assembly 515 may be coupled and/or connector to a USB connector 520. In embodiments, a battery management assembly 515 may convert the DC power to a voltage level utilized by the USB connector 520.

In embodiments, a shading device 500 may comprise one or more processor or microcontroller assemblies 550. In embodiments, the one or more processors or microcontroller assemblies 550 may comprise a system on a chip, where the system on a chip may comprise one or more processors or microcontrollers, one or more memory devices, and/or computer-readable instructions executable by the one or more processors to perform certain actions. In embodiments, the one or more processor or microcontroller assemblies 550 may comprise one or more microprocessors or controllers 554. In embodiments, the one or more microprocessors or controllers 554 may be an ARM microprocessor, an AMD microprocessor and/or an Intel microprocessor. In embodiments, the one or more processor or microcontroller assemblies 550 may comprise a low-power PAN transceiver 551 (e.g., a low power Bluetooth transceiver) and/or a wireless local area network transceiver 552 (e.g., a WiFi transceiver for example at 1.2 and/or 2.4 Gigahertz WiFi transceiver). In embodiments, the one or more processor or microcontroller assemblies 550 also may include a Controller Area Network (CAN) controller 553 (which may also be an ANT controller). In embodiments, the one or more processor or microcontroller assemblies 550 may comprise one or more cellular transceivers 556 (e.g., one or more 2G, 3G or 4G cellular transceivers). In embodiments, the one or more processor or microcontroller assemblies 550 may utilize a CAN bus and/or ANT bus to communicate with devices within the assemblies 550 and/or with other devices, assemblies and/or components in the shading device 500. In embodiments, the one or more processor or microcontroller assemblies 550 may also comprise a clock device 555. In embodiments, the clock device 555 may comprise a real time clock. In embodiments, the clock device 555 may not be installed or be resident on the one or more processor or microcontroller assemblies 550. In embodiments, the one or more processor or microcontroller assembly 550 may be a Libre system-on-chip processor. In embodiments, the one or more processor or microcontroller assembly 550 may be a Nordic Semiconductor NRF42832 system-on-a-chip.

In some embodiments, the computer-readable instructions may be executable by one or more processors 554 in the one or more processor or microcontroller assemblies 550 to communicate with the one or more motor systems or subassemblies 540, the one or more lighting systems or assemblies 530 and/or the one or more audio systems 580. In some embodiments, a mobile computing device (e.g., mobile phone, tablet, wearable computing device, etc.) may communicate instructions, commands and/or messages with the one or more processors 554 utilizing the one or more low-power PAN transceiver 551, the and/or the one or more wireless LAN (or WiFi) transceivers 552, the one or more ANT or CAN controllers 553 and/or the one or more cellular transceivers 556, which are then communicated to the other components, assemblies and/or devices in the shading device 500.

In some embodiments, one or more buttons 560 may be pressed and/or activated which may send a signal and/or command to the one or more processor or microcontroller assembly 550 to have the shading device 500 perform certain actions (such as activating and/or deactivating certain components and/or assemblies (e.g., one or more lighting systems or assemblies 530 and/or one or more motor systems and/or assemblies 540). In some embodiments, one or more buttons 560 may communicate commands or messages to activate or deactivate one or more of the PAN transceiver 551, the WiFi transceiver 552, the microprocessor or controller 554, the one or more cellular transceivers 556, and/or the memory devices (e.g., to take the shading device out of a sleep state). In embodiments, only certain components or transceivers may be activated.

In some embodiments, one or more wind sensors 570 may monitor wind speed in an environment surrounding the shading device 500. In some embodiments, the one or more wind sensors 570 may communicate a wind speed measurement to the one or more processor or microcontroller assemblies 550. In embodiments, the computer-readable instructions executable by one or more processors 554 in the processor or microcontroller assembly 550 may receive the wind speed measurement, compare the received wind speed measurement to a threshold value, and if the received wind speed measurement is over the threshold value, communicate instructions, messages, commands and/or signals to the motor system 540 to cause the motor system to retract the arm or blade assemblies from an open position to a storage or retracted position. In embodiments, this protects a shading device 500 from potentially tipping over due to high winds. In embodiments, the one or more wind sensors 570 may include computer-readable instructions and/or a processor (or similar circuitry) to determine whether or not the captured wind speed measurement is greater than a threshold measurement. If the one or more wind sensors (along the processor and computer-readable instructions (or circuitry) determines the captured wind speed measurement is greater than the threshold value, the one or more wind sensors 570 may communicate a signal, command, message or instruction to the one or more processors 554, via a bus. In response, computer-readable instructions executable by the one or more processors 554 may communicate instructions, messages, commands and/or signals to the motor system 540 to cause the motor system 540 to retract the arm or blade assemblies to a closed position.

In some embodiments, one or more motor systems 540 may be utilized to retract and/or open one or more arms or blades (and/or a frame system) along with associated shading fabric to provide shade or protection to users, operators and/or devices being protected by the shading device 500. In embodiments, the one or more motor systems 540 may include a rack gear assembly, which may be described in detail later, a cable and rope assembly and/or a threaded rod or bolt to expand and/or retract the arms, blades or frame. In the embodiment illustrated in FIG. 5A, the shading device 500 may only comprise one motor system 540 to open and/or close the arms, blades or frame of the shading device. In embodiments, the one or more motor systems 540 may comprise one or more limit switches 545. In embodiments, the one or more limit switches 545 may prevent motors in the one or more motor systems 540 from rotating at too high of a speed or from generating too much torque.

In some embodiments, the shading device 500 may comprise one or more lighting systems or assemblies 530. In embodiments, the one or more processors and/or microcontrollers 554 may communicate instructions, commands, signals and/or messages via a bus (e.g., a CAN bus) to the one or more lighting systems or assemblies 530 to activate and/or deactivate the lighting assemblies 530. In embodiments, the one or more lighting assemblies 530 may be dimmable or may have adjustable settings. In embodiments, the one or more lighting assemblies 530 may be synchronized to music being played or reproduced via the audio system 580. In embodiments, the instructions, commands, signals or messages that request or control lighting system synchronization with audio being played or that request dimming or adjusting of the lighting assemblies 530 may be communicated from the one or more processors 550 in the one or more microprocessor or microcontroller assemblies 550. In embodiments, the one or more lighting assemblies 530 may comprises a lighting controller and/or one or more lighting elements. In embodiments, the one or more lighting elements 530 may be LED light bulbs, fluorescent light bulbs or filament-based light bulbs. In embodiments, the one or more lighting assemblies 530 may be integrated into the one or more arms or blades of the shading device.

In some embodiments, an audio system 580 may comprise an additional PAN transceiver 582, one or more amplifiers 583 and/or one or more speaker assemblies 584. In embodiments, the additional PAN transceiver 582 may be a BlueTooth transceiver, a Zigbee transceiver and/or other PAN transceiver. By having an additional PAN transceiver 582 additional direct communications may be communicated to the audio system 580 without passing through one or more processors or transceivers in the microcontroller assembly 550. In other words, the PAN transceiver in the microcontroller assembly 550 may not be utilized. This may allow faster playing and/or streaming of music to the audio system 580 in the shading device 500. This is an improvement as compared to how other umbrellas may communicate audio files to an umbrella. In some embodiments, the use of a PAN transceiver 552 in the one or more processor or microcontroller assemblies 550 may allow communication to another assembly, component or device (e.g., motor assembly 540 or lighting assembly 530 within the shading device while there is communication of or streaming of audio files through the PAN transceiver 582 in the audio system or assembly 580. In embodiments, this may allow for more efficient and quicker operation of a shading device 500. In embodiments, streamed and/or downloaded audio files may be communicated through the additional PAN transceiver 582 to the one or more amplifiers 583 and then to the one or more audio speakers 584. In some embodiments, a radiator 586 may enhance sound quality and the radiator 586 may be placed between the one or more amplifiers 583 and the one or more audio speakers 584.

In some embodiments, power (e.g., voltage and/or current) may be supplied to different components and/or assemblies of the shading device 500. In embodiments, different DC voltages may need to be supplied to different components, devices and/or assemblies of the shading device. In embodiments, some components, devices or assemblies may utilize 12 to 14 Volts DC as an input voltage, whereas other components, device or assemblies may utilize 3.3 to 5 volts DC as an input voltage. In embodiments, the battery management assembly 515 may transfer power to devices that require 12 to 14 Volts DC through a power bus that is separate from a CAN bus. In embodiments, the battery management assembly 515 may transfer power to one or more voltage regulators 575 and the one or more voltage regulators 575 may communicate 3.3 to 5 Volts DC, via a power bus, to the components or devices that require these voltages for operation. In embodiments, one or more batteries 515 may need to be recharged by a source separate from a solar panel (due to cloudy weather, storage, malfunction, etc.) In some embodiments, a shading device 500 may comprise a connector 587. In some embodiments, a cable may connect an AC power source 588 to the connector 587 to provide additional, supplemental or primary power to operate the shading device 500 and/or recharge the battery power source 515. In some embodiments, an audio system 580 may comprise one or more passive radiators 586 to improve sound quality. In some embodiments, an audio system 580 may also comprise a woofer, subwoofer, tweeter or additional amplifiers or a combination thereof to provide better audio quality to a user.

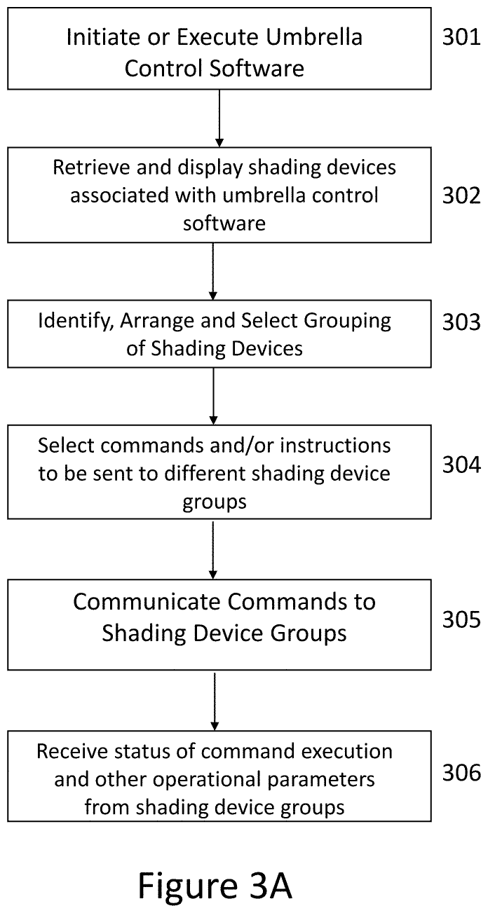

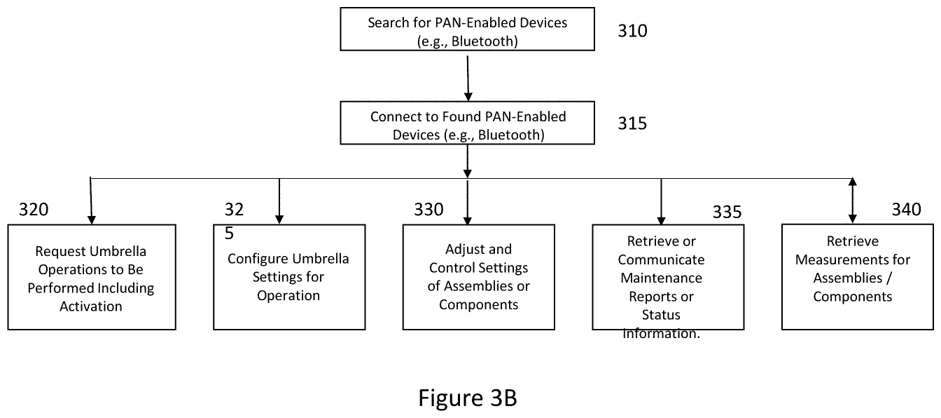

In some embodiments, computer-readable instructions may be stored in one or more memory devices of one or more computing devices and may be executable by one or more processors to perform shading device operations or to cause a shading device to perform certain functions and/or features. In some embodiments, the computer-readable instructions may be referred to as software, application software, server software, distributed software or client-server software or a combination thereof. In some embodiments, software controlling a plurality of parasols, umbrellas, voice-controlled hubs or other shading devices may be referred to as fleet management software and/or multi-parasol device control software. FIG. 3A illustrates a method of controlling multiple shading devices through fleet management or multi-parasol control software according to embodiments. In embodiments, the software may be installed within one or more shading devices and may be activated by voice control. In embodiments, the software may be installed or resident within a mobile computing device (and/or local or remote server devices) and the mobile computing device may execute the software in order to communicate commands, instructions, messages and/or signals to control operations of the one or more shading devices. Similarly, as described above, a smart home device or an external local or remote computing device may execute software installed therein (and also within server devices) in order to communicate commands, instructions, messages and/or signals to one or more shading devices to control or manage operations.

Embodiments described herein are meant to be illustrative examples rather than be limiting with respect to claimed subject matter. Likewise, an embodiment may be simplified to illustrate aspects and/or features in a manner that is intended to not confuse and/or hide claimed subject matter through specificity and/or details. Embodiments in accordance with claimed subject matter may include all of, less than all, or more than blocks 301-306. In embodiments, the order of blocks 301-306 may merely be an illustrative order and other orders may be possible.

In some embodiments, a shading device user or operator may initiate or execute 301 fleet management or multi-shading device control software. In embodiments, a computing device may transmit or communicate, via wireless and/or wired communications, commands, messages or instructions to shading devices to discover which shading devices are up and/or operational and potentially available for fleet management or multi-shading device control.

In some embodiments, a computing device may receive messages, commands and/or instructions from the shading devices that are able to be controlled via the fleet management software and the fleet management software (or multi-shading device software) may display 302 available shading devices to be controlled or simultaneously operated.

In some embodiments, a shading device user or shading device operator may identify, arrange and/or select 303 a grouping for devices. In some embodiments, the fleet management software or multi-shading device control software may receive 303 the commands, instructions or messages identifying, arranging and selecting a group of shading devices to be controlled. In some embodiments, for example, there may be eight shading devices that fleet management software or multi-shading device control software is able to control. In some embodiments, a shading device user or operator may select to put three of the shading devices in a Group 1 and five of the shading devices in a Group 2. In embodiments, a shading device user or operator may select to put all eight of the shading devices in a Group 3. In other words, the fleet management or multi-shading device control software may allow for the shading devices to be put in a number of different groups in order to receive different commands or different instructions at different times and/or under different situations.

In some embodiments, a shading device user or shading device operator may select messages, commands and/or instructions that are to be sent, transmitted and/or communicated to different shading device groups 304. In some embodiments, the fleet management software or multi-shading device control software may receive 304 the selected messages, commands and/or instructions that are to be communicated to the selected shading device groups. In some embodiments, utilizing the illustrative embodiment above for example, the fleet management software or multi-shading device control software may receive music playback commands, instructions or messages for the Group 1 shading devices (three shading devices) and may receive shading device movement commands and/or shading lighting commands for the Group 2 shading devices (five shading devices). In some embodiments, for example, the fleet management software or multi-shading device control software may receive shading device sun tracking commands for the Group 3 shading devices (eight shading devices).

In some embodiments, the fleet management software or multi-shading device control software may communicate or transmit 305 the selected messages, commands, and/or instructions to the selected shading device groups via wireless communication networks and/or wired communication networks. In some embodiments, the messages, commands and/or instructions may be communicated and/or transmitted to all the group shading devices simultaneously, sequentially and/or at specified timeframes. In some embodiments, the messages, commands and/or instructions may be communicated or transmitted automatically, in response to a user or operator selection via a mobile device input (e.g., touchscreen, keyboard, stylus) and/or via voice command inputs. In some embodiments, the messages, commands and/or instructions may be transmitted or communicated by a personal area network transceiver (e.g., Bluetooth, BLE (low power), Zigbee or others), a WiFi transceiver, a wireless LAN transceiver, a cellular transceiver, or a ULE (or ULE DECT) transceiver or a combination thereof and received by corresponding transceivers in the selected shading devices. Other wireless communications transceiver, similar to those discussed above, may also be utilized.

In embodiments, the fleet management software or multi-shading device control software may receive communications back (or transmitted/communicated) from 306 the one or more shading devices in the selected shading device groups. In some embodiments, the communications may be messages, instructions, commands, status parameters, measurements, and/or operational parameters. In some embodiments, the communications may be whether or not the shading device performed the requested actions specified in the transmitted communications. In some embodiments, the communications back from the shading devices may include operational status parameters from the selected shading device groups. In embodiments, the communications back from the shading devices may be measurements, parameters, and/or data (as well as shading device indicators or identifiers) gathered from sensors, devices and/or components of the one or more selected shading devices and/or groups.

FIG. 3B illustrates a mobile communications device (or other computing device) communicating with a plurality of shading devices according to some embodiments. In some embodiments, a mobile communications device (or other computing device) may be able to communicate with and/or receive communications from one or more shading devices, as discussed above. In other words, there is bidirectional communications, unlike with other prior existing shading devices and specifically remote control, where there is only one way communication. In some embodiments, in order to initiate communications between a mobile communications device (or other computing device) and more than one shading devices, a mobile communications device (or other computing device) may search 310 for other personal area network (PAN)-enabled shading devices. In embodiments, the PAN protocol may be Bluetooth, Bluetooth Low-Energy (BLE) or Zigbee. Although FIG. 3B is described with respect to Bluetooth (or PAN) wireless protocol, the below discussion may also be implemented utilizing 802.11, WiFi and/or cellular wireless communication protocols. In some embodiments, the mobile communications device (or other computing device) may connect 315 to found or established PAN-enabled shading devices. In some embodiments, for example, the BLE transceiver of the mobile communications device (or other computing device) may connect with four shading devices, which each have a BLE transceiver. In some embodiments, for example, the WiFi transceiver of a mobile communications device may connect to six shading devices, each which have a WiFi or other 802.11 transceiver.

In some embodiments, the mobile communications device (or other computing device) may perform a number of actions with and/or receive data from a plurality of shading devices. In some embodiments, the mobile communications device (or other computing device) may request 320 that one or more umbrella operations be performed including but not limited to activation of one or more components and/or assemblies of the one or more shading devices.

In some embodiments, the mobile communications device (or other computing device) may transmit commands, instructions, parameters and/or measurements to configure 325 settings of components and/or assemblies of the one or more shading devices. In some embodiments, the settings may include threshold temperature, humidity, or air quality readings and/or an initial resolution for a camera to capture image. In some embodiments, the settings may include which initial light intensity values and/or initial sound system volume values.

In some embodiments, the mobile communications device (or other computing device) may transmit commands, instructions, parameters and/or measurements to adjust and/or control 330 settings of assemblies and/or components in the one or more shading devices. In some embodiments, these settings may be a rotation of a support assembly with respect to a base assembly. In embodiments, these settings may be an elevation angle of an upper support assembly with respect to a lower support assembly or these settings may be whether the arm expansion assembly (or rack gear assembly) is in a closed and/or open position.

In some embodiments, the mobile communications device (or other computing device) may retrieve, access, request and receive 335 status messages or parameters and/or maintenance reports from the one or more shading devices. In embodiments, for example, the status messages or parameters or maintenance reports may include status of the one or more motor assemblies or controllers in the shading devices and/or the status of any of the environment sensors or directional sensors present in the one or more shading devices. In some embodiments, for example, the maintenance reports and/or status messages or parameters may include reports retrieved from an integrated computing device within one or more shading devices, which may have been storing data or information in one or more memory devices.

In some embodiments, the mobile communications device (or other computing device) may also retrieve and/or receive 345 measurements and/or parameters from components and/or assemblies in the one or more shading devices. In embodiments, for example, the mobile communications device (or other computing device) may receive measurements from the one or more sensors including temperature readings, wind readings, humidity readings, air quality readings, latitude and/or longitude readings. In embodiments, for example, the mobile communications device (or other computing device) may receive measurements from the solar power charging assembly and/or solar panels with respect to power generated and/or power utilized. In embodiments, for example, the mobile communications device (or other computing device) may receive video and/or images from the cameras in the one or more shading devices.

Below described is possible potential communications between mobile communication device (or other computing device) and/or a plurality of shading devices. In embodiments, an important feature of the shading devices of Shadecraft is an ability for a mobile computing device to communicate with, control and/or receive data, information, parameters or measurements from the two or more shading devices. In embodiments, the utilization of Bluetooth Low Energy (BLE) allows for reduction in power consumption by the umbrellas. This is important for solar powered umbrellas where there may be a limited amount of power available. In some embodiments, a mobile communications device (or other computing device) may communicate with multiple shading devices. In embodiments, the mobile communications device may control operations of the multiple shading devices. In some embodiments, the mobile communications device may receive data, information, parameters and/or measurements from the multiple shading devices. In some embodiments, in order to conserve energy, many of the communications between the mobile communication device (or other computing device) and the

In embodiments, a Generic Attribute Protocol (GATT) may be utilized for communications between a mobile communications device and the one or more shading devices. In embodiments, a mobile communications device (or a computing device) may be a GATT server or control device and the multiple shading devices may be GATT client devices. In embodiments, a GATT client (shading device) may communicate with one GATT server device (e.g., mobile communication device) during a session and may be thus be only utilizing power for that communication. If the GATT protocol is utilized, whereas the GATT server device may be communicating with a number of GATT client devices at one time, the GATT client device (shading device) may only communicate with one GATT server device (mobile communication device or computing device) at a time. In some embodiments, other protocols may also be utilized to allow the shading devices to have alternative communication paths.

In embodiments, the mobile communications device may be able to control and/or then observe and receive status of shading device activities. In embodiments, then the mobile communications device may receive performance measurements and/or parameters, audio and/or video, and/or environmental or directional parameters, measurements and/or information from the shading device and display such within the shading device application software on the mobile communication device. In embodiments, the activities of the multiple shading devices that may be controlled may be: 1) the expanding or opening and the closing of the arms or blades of the shading device; 2) the rotating of the shading device about an azimuth axis and/or about a base assembly; and/or the 3) the tilting of a portion of the shading device with respect to another portion of the shading device (e.g., changing in an elevation such as rotating an upper portion of the support assembly with respect to a lower portion of the support assembly). In embodiments, the activities of the multiple shading devices that may be controlled may be a calibration of a direction of the shading device; setting of a date and/or time for the shading device; setting sun rise time for automatic operation (e.g., opening or adjusting a shading device); setting sun set time for automatic operation (e.g., closing or adjusting a shading device for sunset); setting up and/or selecting a wireless transceiver (e.g., cellular, WiFi or personal area network—Bluetooth or BLE); and/or update weather conditions or settings for the shading device (e.g., wind sensor sensitivity, temperature and/or humidity sensitivities). In embodiments, the activities of the multiple shading devices that may be controlled may also include: 1) adjusting an intensity of a lighting assembly; 2) pausing and/or playing music or digital music files; 3) controlling volume settings for reproducing sounds; 4) turning on and/or off the camera and/or adjusting camera settings; and/or 5) adjusting a wind sensor sensitivity.

In embodiments, the multiple shading devices (or each shading device) may communicate some of the following parameters, measurements and/or information to the mobile communication device (or other computing device). In embodiments, the parameters, measurements, and/or information may be 1) open and/or close status; 2) directional parameters, measurements and/or information; 3) angular parameters, measurements and/or information; 4) GPS location parameters, measurement and/or information; 5) obstacle detection parameters, measurements, and/or information; 6) presence or motion detection parameters, measurements, and/or information; 7) battery health, percentage left or expended, and/or battery temperature; and/or 8) performance of solar panels and/or solar charging assembly. In embodiments, the parameters, measurements and/or information may also be 1) environmental conditions (e.g., temperature readings, humidity readings, air quality readings, carbon monoxide readings, carbon dioxide readings); 2) wind speed measurement, parameters and/or information; 3) ambient light measurements, parameters, and/or information; 4) ultraviolet sensor measurements, parameters and/or information; 5) rain sensor parameters, measurements, and/or information; and/or 6) lightning sensor parameters, measurements, and/or information.

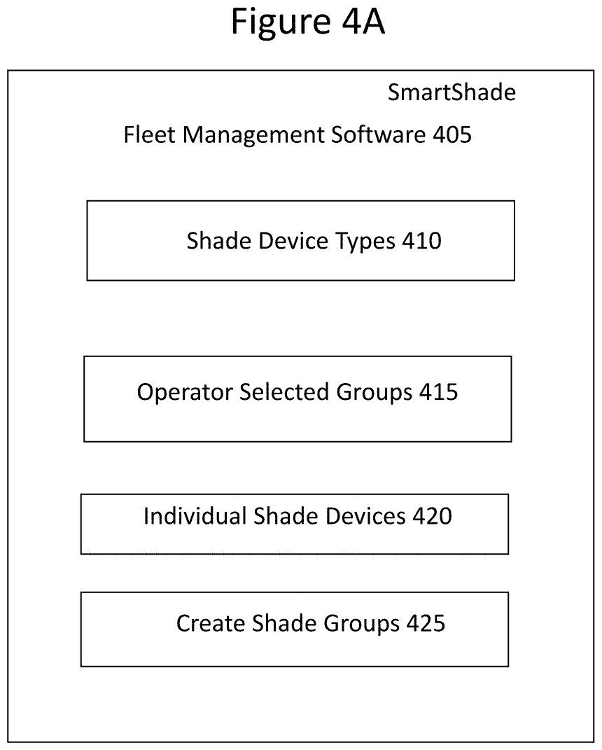

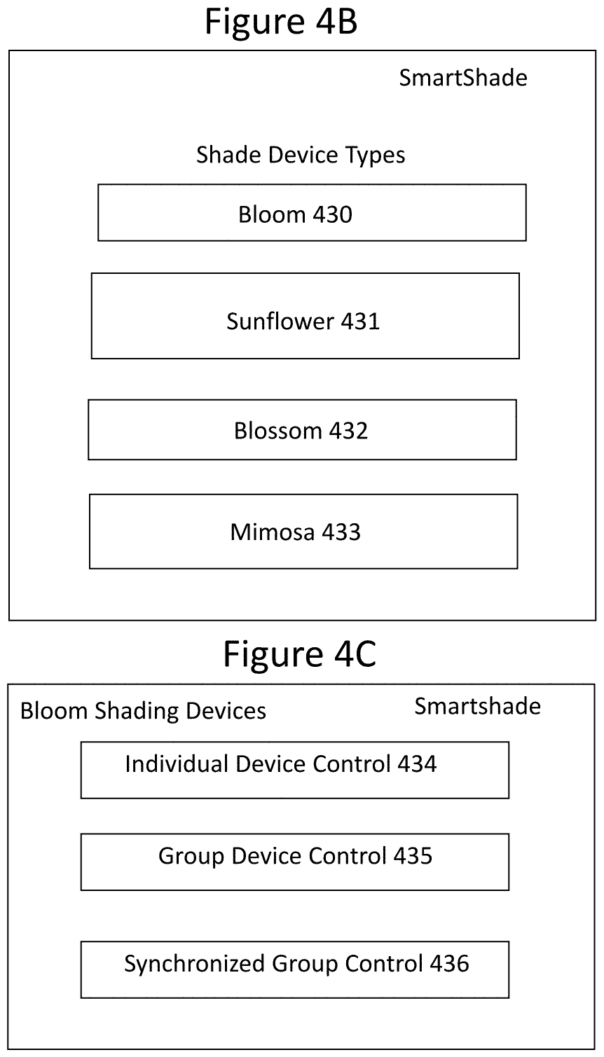

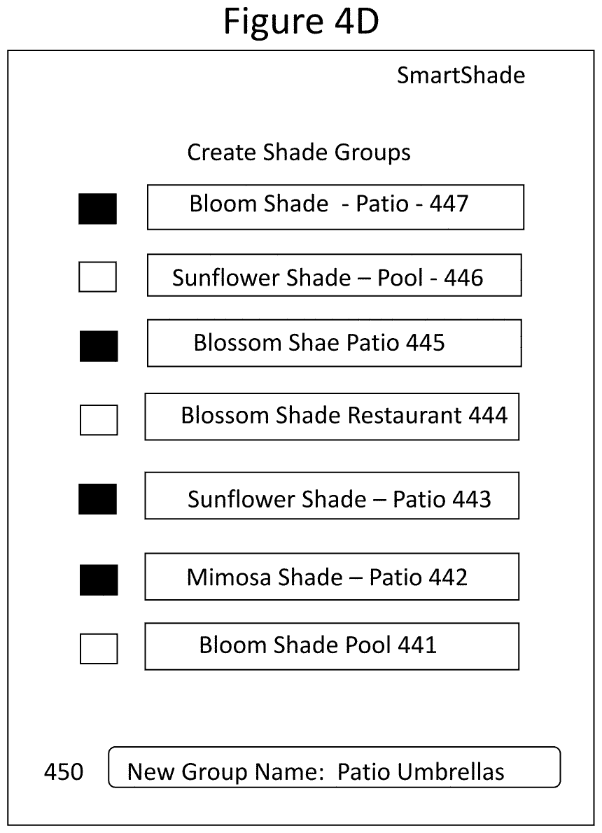

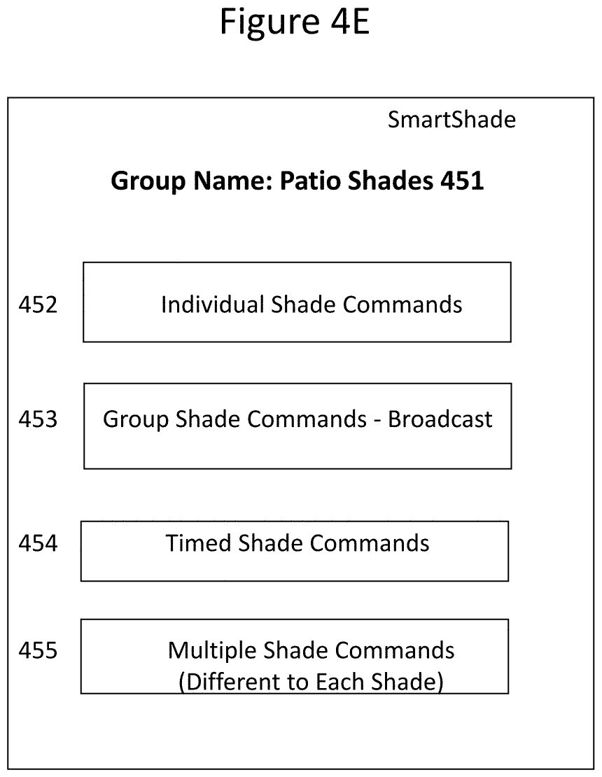

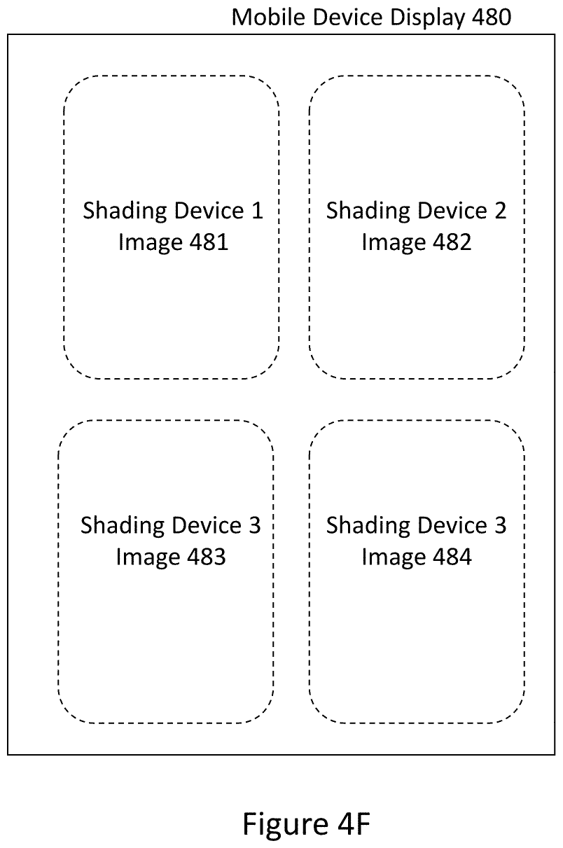

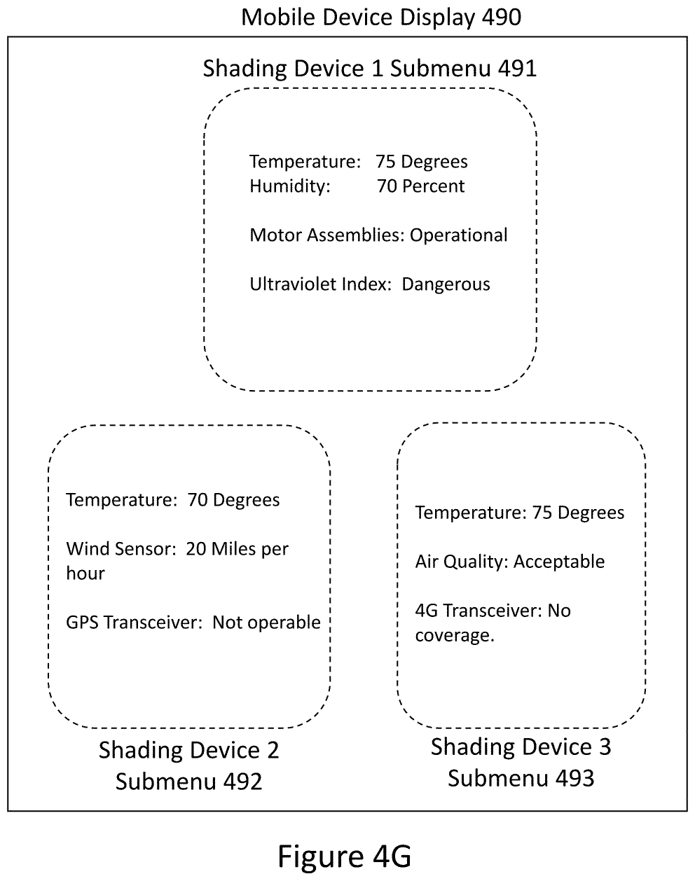

FIG. 4A illustrates fleet management system operation of shading devices according to some embodiments. In embodiments, a mobile computing device may comprise one or more processors, one or more memory devices, one or more wireless transceivers and computer-readable instructions stored in the one or more memory devices. In embodiments, the computer-readable instructions are accessed from the one or more memory devices and are executable by the one or more processors to cause the mobile computing device to control two or more umbrellas and/or shading devices to perform operations and/or receive parameters or measurements. In embodiments, the mobile computing device communicates with web servers, application servers and/or database servers to execute and operate fleet management software (or multiple umbrella control software). In embodiments, the web servers, applications servers and/or database servers may each comprise one or more processors, one or more memory devices. In embodiments, the web servers, application servers and/or database servers may each include computer-readable instructions stored in the one or more memory devices which may be accessed from the one or more memory devices and executed by the one or more web servers, application servers and/or database servers to interface with the mobile computing device and operate and/or execute the fleet management software. In embodiments, different modules or portions of fleet management software (e.g., the computer-readable instructions) may be stored on the different computing devices (web servers, application servers and/or database servers as well as mobile computing devices).

FIG. 4A illustrates fleet management system operation according to embodiments. In some embodiments, a mobile computing device may comprise one or more processors, one or more memory devices, one or more wireless transceivers and computer-readable instructions stored in the one or more memory devices. In some embodiments, the computer-readable instructions are accessed from the one or more memory devices and are executable by the one or more processors to cause the mobile computing device to control two or more umbrellas and/or shading devices to perform operations and/or receive parameters or measurements. In some embodiments, the mobile computing device communicates with web servers, application servers and/or database servers to execute and operate fleet management software (or multiple umbrella control software). In some embodiments, the web servers, applications servers and/or database servers may each comprise one or more processors, one or more memory devices. In some embodiments, the web servers, application servers and/or database servers may each include computer-readable instructions stored in the one or more memory devices which may be accessed from the one or more memory devices and executed by the one or more web servers, application servers and/or database servers to interface with the mobile computing device and operate and/or execute the fleet management software. In embodiments, different modules or portions of fleet management software (e.g., the computer-readable instructions) may be stored on the different computing devices (web servers, application servers and/or database servers as well as mobile computing devices). Although the fleet management software is described herein as being executable by one or more processors on mobile communications devices, the fleet management software may also be executable and/or operable on laptop computing devices, desktop computing devices, tablet computing devices, server computing devices, remote computing devices and/or local computing devices. In some embodiments, the fleet management software may be cloud-based and/or a web-based software application.

FIG. 4A illustrates an initial selection screen in fleet management software according to embodiments. In embodiments, the fleet management software may allow a user or operator to communicate and/or transmit commands, instructions, messages and/or parameters to 1) specific shading device types 410; 2) operator selected groups 415 (which would have been already created); or 3) individual shading devices 420. In embodiments, the fleet management software may also allow a user to create 425 new groups of shading devices and/or edit existing groups of shading devices (although this option is not shown in FIG. 4A).

FIG. 4D illustrates an input screen for an operator to create one or more shading device groups according to embodiments. This is an important advantage SMARTSHADE software (or fleet management software) has in that a user or operator can configure the software to communicate with multiple devices at a time. In addition, because shading devices are portable, the shading devices may move to different areas and may then be placed into a different grouping. Thus, the ability to create new groups provides an advantage in dealing with environments where multiple shading devices may be utilized in different location. This improves the operation of the mobile computing device because the processors are not be utilized to execute software continuously as they would be if the software was only addressing one shading device at time. In embodiments, the computer-readable instructions executable by the processors (e.g., the fleet management portion of the SmartShade software) may generate a list of existing shading devices and present the list of existing shading devices on a screen of a mobile communications device. In embodiments, the fleet management portion of the Smartshade software may also present an input area for a user or operator to name the created shading device group. FIG. 4D provides an illustrative example of a “create shading group” screen. In embodiments, such as illustrated in FIG. 4D, a list of shading devices and locations may be provided along with a selection indicator. In embodiments, for example as illustrated in FIG. 4D, a list may include a Bloom attachment shading device 447 (located at a patio area), a Sunflower shading device 446 (located at a pool), a Blossom single axis expansion shading device 445 (located at the patio area), a Blossom shading device 444 (located at a restaurant area), a Sunflower shading device 443 (located at a patio area), a Mimosa shading device 442 (located at a patio area) and/or a Bloom attachment shading device 441 (located at a pool). In embodiments, a group name input 450 may be provided and in FIG. 4D, the shading group may be entitled “Patio Umbrellas.” In some embodiments, a user or operator may identify which shading devices should be in a group by selecting an indicator box. In embodiments, such as FIG. 4D for example the Bloom attachment shading device 447, the blossom shading device 445, the Sunflower shading device 443 and the Mimosa shading device 442 may be included in the newly created Patio Umbrellas groups. In some embodiments, selections may be made via voice commands to the mobile communications device and the items may be automatically selected by the fleet management software. In some embodiments, selections may be made utilizing gesture recognition. In some embodiments, the computer-readable instructions executable by the one or more processors in the mobile computing device (e.g., SMARTSHADE software or fleet management software) may retrieve, review and/or analyze a list of shading devices and determine shading devices that are similar and may automatically place the same or similar devices into groups based at least in parts on the analysis. In other words, the SMARTSHADE software or fleet management software may automatically create groupings on its own.

FIG. 4B illustrates a shading device type selection screen according to embodiments. In some embodiments, if a user selects to communicate instructions, commands, messages and/or parameters to shading devices based upon groups of devices. In embodiments, for example, the SmartShade application servers and/or database servers may retrieve, if groups of devices are selected, and/or communicate or serve a web page or menu to the user computing device. In some embodiments, the web page or menu identifies different types of shading devices that are available to be controlled and/or communicated with. In FIG. 4B, for example, four shading device types (and thus groups) may be retrieved and presented (e.g., Bloom attachment shading devices 430, Sunflower shading devices 431, Blossom shading devices 432, and/or Mimosa shading devices 433). In some embodiments, a user may select a shading device group to which to communicate instructions, commands, messages and/or parameters. In some embodiments, this selection may be made utilizing voice commands, tactile or keyboard input, touch screen input, automatic selection and/or gesture recognition. In some embodiments, the selection message or instruction may be communicated to the SmartShade application server and/or database server and the application server and/or database server may retrieve and communicate a web page or similar menu to the user's computing device. In some embodiments, the web page or menu may identify different methods of communicating the commands, messages, instructions, and/or parameters to the selected shading devices.

In some embodiments, FIG. 4C illustrates different ways or processes for communicating commands, instructions, messages and/or parameters to the plurality of shading devices. In embodiments, the SMARTSHADE software (or fleet management software) may transmit or communicate individual device commands, instructions, messages and/or parameters; transmit commands, instructions, messages and/or parameters to a selected shading device type either simultaneously or sequentially; and/or transmit commands, instructions, messages and/or parameters to the selected shading device type in order for the shading devices to operate synchronously. In embodiments, as illustrated in FIG. 4C, if a user or operator selected Bloom Shading devices (see FIG. 4B), the fleet management software may retrieve a web page and/or menu from the application server and/or database server and may present shading device control options on a display of a computing device (e.g., such as a mobile computing device). In embodiments, for example, a user or operator may select individual shading device control 434, group device control 435 and/or synchronized group control 436. In some embodiments, if a user or operator selects individual shading device control 434, then commands, instructions, messages or parameters may be communicated to the selected individual shading device. In some embodiments, if the user or operator selects group device control 435, the commands, instructions, messages or parameters may be communicated to a group of shading devices. In some embodiments, if the user or operator selects synchronized group control 436, then the commands, instructions, messages or parameters may be communicated to the group of shading devices to make the shading devices to operate in a specific configuration and timed so that the group of shading devices perform operations simultaneously.

FIG. 4E illustrates another shading device control menu or web page for a selected shading device group according to some embodiments. In some embodiments, the fleet management software may allow a user and/or operator to broadcast commands to the selected group of shading devices. In embodiments, after a user or operator have selected a group name (e.g., selects “Patio Shades”), the fleet management software may retrieve and/or communicate and serve a web page and/or menu where the web page or menu identifies different shading device control options. In some embodiments, as illustrated in FIG. 4E, a user or operator may select to communicate individual shading commands 452 to each individual shading device of the patio shades; broadcast shading commands 453 to the group of shading devices (e.g., “Patio Shades” group); timed shading commands 454 to the group of shading devices (e.g., “Patio Shades” group; or communicate different shade commands to different shading devices 455, but have the shading commands all entered and/or input at one time. This is a significant improvement over anything out in the marketplace and allows for significant time savings for operators and also allows for preplanning events.

In some embodiments, if the user or operator may select to broadcast group shade commands, the fleet management software may receive the commands, instructions, messages or parameters that are to be communicated either via tactile input or voice input (or via other input devices of a mobile computing device). In some embodiments, the fleet management computer-readable instructions may be executable by the one or more processors of the mobile computing device and may communicate the received and/or input commands, instructions, messages or parameters to the one or more wireless transceivers of the mobile computing device. In some embodiments, the one or more mobile communication device wireless transceivers may communicate the received commands, instructions, messages or parameters to one or the one or more wireless transceivers of the selected one or more shading devices. In some embodiments, the one or more wireless transceivers of the mobile communication device may communicate to each of the shading devices at the same time, or at close to the same time. In embodiments, in other words, the one or more wireless transceivers of the mobile communications device may make a broadcast transmission to two or more shading devices, which will receive the broadcast transmission at the shading device's wireless communication transceiver.

In some embodiments, such as hotels, public gathering places, beaches, outdoor restaurants, etc., an owner or operator may own a number of shading devices and/or umbrellas. In some embodiments, the owner or operator may not want to continuously move and/or adjust individual shading devices throughout the day in that it is not efficient and wastes employees' time. The shading devices may be located in different areas of a venue or area and thus may operate under different conditions. Thus, broadcasting the same commands, instructions, message or parameters at the same time may not be a desired sequence for the shading devices in these venues. In some embodiments, a user and/or operator of one or more shading devices and/or umbrellas may communicate one or more sequences of timed commands to two or more shading devices. In some embodiments, fleet management computer-readable instructions executable by one or more processors (e.g., fleet management software) may present a user or operator with a screen or menu to allow entering or submission of commands, instructions, messages and/or parameters that to be communicated to two or more shading devices. In some embodiments, the fleet management computer-readable instructions executable by the one or more processors of the mobile communications device may also receive and/or prompt for a time of execution of the different sequences, strings or sets of commands, instructions, messages and/or parameters. In some embodiments, this allows entrance of different execution times for the different shading devices. In some embodiments, the fleet management computer-readable instructions (e.g., software) executable by the one or more processors of the mobile computing device may communicate the entered or selected sequences of commands, instructions, messages and/or parameters and/or execution timing parameters or values to the one or more wireless transceivers in the mobile communications device. In some embodiments, the one or more wireless communication transceivers in the mobile communications device may communicate the received sequences of commands, instructions, messages and/or parameters and/or the execution timing parameters to the wireless communication transceivers in two or more shading devices. In some embodiments, the two or more shading devices (e.g., computer-readable instructions executable by the one or more processors of the shading device) may each 1) receive the communicated sequences of commands, instructions, messages and/or parameters; 2) receive the execution timing parameters; and/or 3) may cause the shading device components, assemblies and/or systems to complete, at the received execution time values, the actions and/or operations identified in the received sequence of command, instructions, messages and/or parameters. This feature and/or capability allows for the mobile communication device (or other computing device) to be able to free up processing time because the mobile communication device (or other computing device) is not responsible to communicate the sequences commands, instructions, messages or parameters to the one or more shading devices at the different execution times. In some embodiments, for example, in a same sequence of commands, an operator may send commands for a first shading device in a pool area to open the arms or blades, activate one or more environmental sensors and turn on the music at 10:00 am in a pool area and the first shading device may perform the operations at the requested execution time. In this illustrative embodiment, for example, the mobile communication device may also have communicated a second sequence of commands to a second shading device in a restaurant area to open the arms or blades, turn on lighting assemblies, turn on proximity sensors and/or also activate a camera to capture images and stream video starting at 11:00 am when the restaurant opens.

In some embodiments, the user or operator of the fleet management software may able to control operations of a number of umbrellas by entering the sequences of commands, instructions, messages and/or parameters and letting the mobile communications device and/or fleet management software control the operations automatically based at least in part on the entered and then communicated commands. This is a big advantage as compared to communicating with each shading device individually and/or manually moving or adjusting the two or more shading devices to perform specific actions and/or operations. In an alternate embodiment, the fleet management software may receive the selected sequences of commands, instructions, messages and/or parameters as well as the execution timing values or measurements and may wait until the execution time (or close to the execution time) to communicate the selected sequence of commands, instructions, messages and/or parameters to the selected shading device to the one or more wireless transceivers of the mobile communications device and then to the selected and/or identified wireless communication devices in the associated shading device. In some embodiments, as was discussed above for example, the fleet management software may communicate the identified commands, instructions, messages or parameters to the pool shading device around 10:00 am and the identified commands, instructions, messages or parameters to the restaurant shading device around 11:00 am. This embodiment may be utilized when clocks and/or timers are not available in the shading devices receiving the commands and thus these devices cannot keep track of when to execute the received commands, instructions, messages and/or parameters. As is also illustrated in the example above, different sequences of selected commands, instructions, messages and/or parameters may be sent to different shading devices. This is a significant advantage in that it allows a user or operator to control two or more shading devices in different areas of a venue or operation.

Different shade commands to different shading devices 455 but have the shading commands all entered and/or input at one time. In some embodiments, a commercial venue or park or a recreation center may have different areas which each have one or shading devices. In such embodiments, an owner or operator may wish to send different commands or sequences of commands to different shading devices or shading device groupings located in different parts of the commercial venue, park and/or recreation center. In some embodiments, fleet management software may present a menu or screen to an owner, operator or user to enter shading devices (or grouping of shading devices) to receive selected commands, instructions, messages and/or parameters. In some embodiments, the fleet management software may receive the selected commands, instructions, messages and/or parameters and may communicate the received commands, instructions, messages and/or parameters to the one or more wireless communication transceivers. As mentioned above, these may include different sets of commands, instructions, messages and/or parameters for different shading devices and/or groups. In other words, shading device A may receive command set A while shading device group B (with 3 shading devices) may receive command set B. In embodiments, included in the received commands, instructions, messages and/or parameters may be shading device identifiers or addresses to identify which shading device is to receive which selected commands, instructions, messages and/or parameters. In some embodiments, the one or more wireless communication transceivers may communicate the one or more sequences of received commands, instructions, messages and/or parameters to the different identified shading devices and/or shading devices groupings. In some embodiments, depending on the type or wireless communications protocol used, the one or more wireless communication device may communicate the received commands, instructions, messages and/or parameters to the different shading devices or shading device groupings simultaneously and/or in parallel. In other words, command and instruction set A may be communicated to a first shading device at the same time or in parallel with command and instruction set B being communicated to a second and third shading device. In some cases, PAN transceivers and/or WiFi or 802.11 transceivers may be able to communicate sequences of commands or command sets simultaneously (in the mobile communication device) and/or to receive sequences of commands or command sets (in the shading devices). In some embodiments, in an illustrative example, a recreation center may include a pool and outdoor changing area with one or more shading devices and picnic tables having three shading devices providing sun protection. In some embodiments, during a party for example, a user or operator may desire to move people from the pool and changing area to the picnic tables. In this illustrative embodiment, for example, a user or operator (in a different part of the recreation center) may enter commands, instructions, and/or messages to 1) cause the one or more shading devices at the pool to close and may also play a recorded message indicating the pool portion of the party is now ending and to move to the picnic area for food; and 2) to open the three shading devices at the picnic tables and begin to play music at the three shading devices. In some embodiments, the fleet management software, utilizing the one or more wireless transceivers, may communicate the first command sequences to the first shading device and may simultaneously communicate (or at the same time) the second command sequences to other three shading devices), where the shading devices each have wireless communication transceivers. In some embodiments, the one or more wireless communication transceivers may communicate the one or more sequences of commands, instructions, messages and/or parameters sequentially to the different identified shading devices. In embodiments, sequential transmission or communication of commands, instructions, messages and/or parameters may occur due to limited bandwidth of the wireless network, limited availability or processing power of the mobile communication devices and/or other technical factors or considerations. Thus, utilizing the example above, the fleet management software may alternatively first communicate the selected sequence of commands to the pool shading device(s) (which they receive utilizing the shading device wireless communication transceiver and then sequentially communicate a different selected sequence of commands to the other three shading devices (which are received utilizing the shading device wireless communication transceivers).

In some embodiments, a mobile communications device or other computing device may include two or more wireless communication transceivers operating under different wireless communication protocols. In embodiments, in a venue or property or other area, a first group of shading devices may have only PAN wireless transceivers and a second group of shading devices may only have WiFi or 802.11 wireless communication transceivers. In some embodiments, the fleet management software may automatically recognize these communication capabilities during initialization of a system and/or by attempting to establish communications between the mobile communications device (or other computing devices) and/or the shading devices. In some embodiments, a user or operator may also enter this information into the fleet management software. In some embodiments, a user or operator may also enter a preferred method of wireless communications between a mobile communications device and/or a phone in order to deal with bandwidth issues and/or cost issues. In some embodiments, the fleet management software may store the wireless communication capability of the different shading devices in one or more memory devices of the mobile communications device and/or computing device. In embodiments, a user or operator may enter a first set of commands, instructions, parameters and/or messages for Shading Device Group A (a first and second shading device) and a second set of commands, instructions, parameters or messages for Shading Device Group B (a third and fourth shading device). In some embodiments, the fleet management software may retrieve the communication capabilities for Shading Device Group A (e.g., a PAN wireless transceiver) and Shading Device Group B (e.g., a WiFi or 802.11 wireless transceiver). In some embodiments, the fleet management software may communicate the first set of commands, instructions, messages and/or parameters to the PAN wireless transceiver which in turn communicates the first set of commands, instructions, messages and/or parameters to the PAN wireless transceivers in the first and second shading devices. Simultaneously (or sequentially), in some embodiments, the fleet management software may communicate the second set of commands, instructions, messages and/or parameters to the third and fourth shading devices via the WiFi wireless transceiver. Again, this is a clear advantage over any known control of multiple shading objects because the fleet management software can control multiple shading objects even if the shading objects have different wireless communications protocols and/or transceivers. In some embodiments, the fleet management software may be able to handle simultaneously communication to different shading devices via one or more wireless communication protocols, including, but not limited to DECT protocol, cellular communication protocols, WiFi or 802.11 protocols, personal area wireless network protocols (e.g., Bluetooth or Zigbee), low energy (e.g., BLE—Bluetooth Low Energy) wireless communication protocols and/or other protocols.

In some embodiments, while the above description may include descriptions of communicating and/or transmitting sets or sequences of commands, instructions, messages and/or parameters, a user and/or operator may simultaneously or sequentially communicate commands, may communicate in a broadcast; or may communicate to individual shading devices one command (or one command to each shading device). The discussion above applies to communicating one command, multiple commands, sets of commands and/or sequences of commands to one or two or more shading devices. Likewise, in some circumstances, the term “command” is utilized alone and not with instructions, messages and/or parameters. In many cases, this is done to simplify and streamline the application and the term “command” may be substituted with instructions, messages and/or parameters. In other words, if the specification only refers to commands, then the actions may also be applied or utilized with respect to instructions, messages and/or parameters.

In some embodiments, different computing devices and/or electronic devices may be able to control multiple shading devices or multiple groups of shading devices. While there has been a discussion regarding mobile communication devices (e.g., tablets, smartphones, mobile phones, wearable computing devices, and/or laptop computing devices) including fleet management software, the fleet management software may also be loaded and/or stored into memory devices and/or executable by one or more processors of different computing devices, such as desktop computing devices, server computing devices smart appliances, smart home devices, television controllers, home security devices and/or control panels and/or IoT-enabled computing devices. In embodiments, the listed devices above may communicate with and/or control one or more shading devices utilizing existing communication protocols utilized by the devices listed above. In some embodiments, for example, desktop computing devices and/or server computing devices may utilize wired communication protocols and/or wireless communication protocols to communicate with the one or more shading devices. In some embodiments, smart appliances, smart home devices, home security devices and/or IoT-enabled computing devices may communicate with and/or control operation of the one or more shading devices via various communication protocols, including but not limited to, Internet Protocol Version 6 (IPv6) communication protocol, over Low power Wireless Personal Area Networks (6LoWPAN) communication protocol, ZigBee communication protocol, Bluetooth Low Energy (BLE) communication protocol, Z-Wave communication protocol and Near Field Communication (NFC) communication protocol. In addition, IoT communication protocols may be short-range standard network protocols, while SigFox and Low Power Wide Area Network (LPWAN).standard protocols communication protocols.

FIG. 4F illustrates a screen of a mobile communication device operating fleet management software and receiving video or images from two or more shading devices according to embodiments. In embodiments, the fleet management software may receive communications back from two or more shading devices after initializing communicating commands, instructions, parameters and/or measurements to the two or more shading devices. In embodiments, for example, the commands, messages or instructions may request that the two or more shading devices communicate back video and/or images to allow a user or operator of the fleet management software of images of areas around the shading devices. In this illustrative embodiment, for example, the two or more shading devices may activate the cameras integrated within the two or more shading devices, which may communicate the images and/or video through the one or more wireless communication transceivers back to the mobile communication device (or other computing device). In embodiments, the one mobile communication device (or other computing device) may receive the images and/or video at its one of the one or more wireless communication transceivers and may transfer the images and/or video to a display of the mobile communications device as is shown in FIG. 4F. In FIG. 4F, the mobile communications device display 480 includes four display screens. In embodiments, the four display screens may include display screen 1 481 which displays images and/or video received from shading device 1; display screen 2 482 which displays images and/or video received from shading device 2; display screen 3 483 which displays images and/or video received from shading device 3; and/or display screen 4 484 which displays images and/or video received from shading device 4. This is an improvement over any existing shading devices systems. In embodiments, not only can the mobile communication device control operations of two or more shading devices, but the mobile communication device also receives live images and/or video from different shading devices located in different areas of a venue. This provides security benefits as well as allowing a user or operator to understand needs of customers at the different shading devices.

FIG. 4G illustrates a screen of a mobile communication device operating fleet management software and receiving status measurements and/or parameters from two or more shading devices according to embodiments. Figure 4G illustrates three submenus 491 492 493 of a mobile communications device operating fleet management software. In embodiments, three shading devices communicate status measurements and/or parameters with the mobile communications device or other computing device and the mobile communications device displays the received information on its display in a menu 490. In embodiments, for example, fleet management submenu 491 displays illustrative status measurements and/or parameters received from the temperature sensor of shading device 1, the humidity sensor of shading device 1, the one or more motor assemblies of shading device 1 and/or the ultraviolet sensor of shading device 1. In embodiments, for example, fleet management submenu 492 displays illustrative status measurements and/or parameters received the temperature sensor of shading device 2, the wind sensor of shading device 2, and/or an operational status of GPS transceiver of shading device 2. In embodiments, for example, fleet management submenu 493 displays illustrative status measurements and/or parameters received from the temperature sensor of shading device 3, the air quality sensor of shading device 3 and/or from one or more wireless transceivers of shading device 3. These submenus are illustrative. In embodiments, the fleet management software may generate multiple submenus depending on the number of shading devices being controlled. In embodiments, the submenus may display status measurements and/or parameters from any number of components and/or assemblies. In embodiments, the submenus may display only status measurements that are above predetermined thresholds and/or in dangerous conditions. In embodiments, an operator and/or user may determine which status measurements and/or parameters are to be displayed in a submenu associated with a shading device. In embodiments, for example, an operator and/or user may set up the submenus to display the same measurements and/or parameters received from the same components and/or assemblies for each of the shading devices. In embodiments, an operator and/or user may setup submenus to display different measurements and/or parameters received from different components and/or assemblies in the different shading devices. In other words, the different submenus may display different readings or status indicators for each shading device, as is illustrated in FIG. 4G.

In some embodiments, a mobile communications device (or other computing device) may receive touchscreen input to control operations and/or use of the fleet management software. In embodiments, the fleet management software may be operated utilizing voice recognition. In other words, the user may utilize voice commands to operate the fleet management software. In embodiments, the mobile communications device (or other computing device) may include voice recognition software to convert the spoken words into the commands, instructions, and/or messages communicated to the one or more shading devices. In embodiments, in order to execute the voice recognition software, the mobile communication device may transfer the received audio files (or text files) to a voice recognition server in a cloud-based server, which then communicates back commands, instructions and/or messages that may be communicated to the two or more shading devices to control operations, receive video and/or images from the two or more shading devices, and/or receive status parameters and/or messages from the two or more shading devices

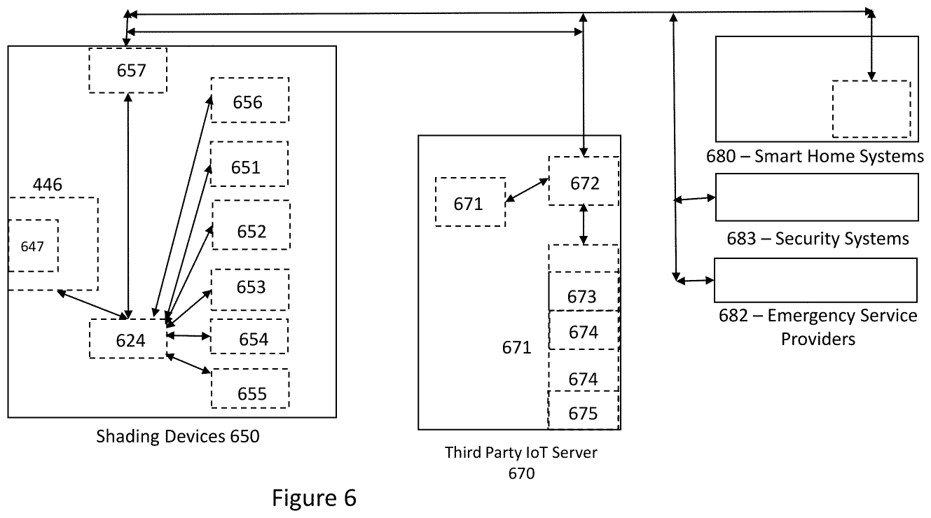

FIG. 6 illustrates a shading device communicating with an IoT-enabled server or computing device according to embodiments. If a modular umbrella system is integrated into IoT, for example, one or more shading devices 650 and/or IoT-enabled devices integrated or installed thereon may be part of a smart home, a smart office and/or a smart city. For example, a smart home may already include one or more IoT-servers 670 (e.g., a NEST server may have a computing device and/or server) for controlling operations of IoT devices (alarms, appliances, or lights) installed within a smart home, office or building. In some embodiments, one or more shading devices 650 (and one or more IoT-enabled devices) may be incorporated into such a smart home, office or building. For example, one or more environmental sensors (e.g., temperature, humidity, air quality, UV radiation, wind speed sensors, and/or a digital barometer) may capture and communicate measurements and/or status readings to an IoT-enabled smart home server 670. In some embodiments, measurements and/or status readings may be communicated using a smart home API 647 (instructions executed by a processor) through a modular umbrella system transceiver 657 (e.g., local area network wireless (or WiFi) transceiver, cellular transceiver, PAN transceiver) to an IoT-enabled smart home server 670. In embodiments, temperature and/or humidity measurements from a temperature and/or humidity sensor 651 may be communicated to the IoT-enabled smart home server, where the IoT-enabled smart home server 670 may analyze the temperature and/or humidity measurements and may adjust commands, instructions and messages transmitted to cooling and/or heating systems 680 in a smart home. In embodiments, UV radiation sensor measurements and/or air quality sensor measurements from a radiation sensor or air quality sensor 652 may be communicated to an IoT-enabled smart home server 670, the UV measurements may be utilized as input for a personal health software application 673 (e.g., recommend sunscreen or period of sun exposure recommended for a home resident) and/or may be stored for later reporting and/or analyzation. In embodiments, a UV radiation sensor is not a light sensor in that it measures UV radiation and not irradiation, brightness or intensity. In embodiments, air quality sensor measurements may be utilized 1) as input for a personal health software application (e.g., recommend whether to take asthma medication, whether to where mask due to large amount of allergens in air); 2) to trigger alarm conditions within a smart home (e.g., carbon monoxide or other gas readings too high); and/or 3) by the smart home server to communicate with emergency service provider servers or computing devices 682 (e.g., utility companies, fire departments, police departments) due to over threshold and dangerous sensor measurements. In embodiments, barometer measurements from a barometer 653 may be utilized by IoT-enabled smart home servers 670 as input for a weather software application 674 as one of a plurality of factors utilized for determining and/or predicting weather conditions.

In some embodiments, solar cells and/or cells 654 (and/or a solar charger assembly) may communicate solar panel status and/or solar power measurements to a smart home server 670 via a smart home application programming interface (API) 647 utilizing a wireless or wired communication transceiver 657. In embodiments, a smart home server 670 may receive solar panel (or cell) status and determine whether to alert a solar cell maintenance computing device as to a potential service call. In embodiments, a smart home server 670 may receive solar panel or cell power generation measurements and utilize these to identify solar power generated by user of smart home (e.g., add it to any green power generated by smart home). In embodiments, a smart home server 650 may receive solar power generation measurements as well as unused solar power measurements and identify whether or not to draw excess power from one or more shading devices.

In embodiments, sensors on one or more motor assemblies (or motor assemblies themselves (if IoT enabled)) 655 may communicate motor assembly status and/or motor assemblies failure codes to an IoT-enabled smart home server 670 via a smart home API 647 utilizing a transceiver 657. In embodiments, a smart home server 670 may receive communicated motor assembly status and/or failure codes and may contact a maintenance computing device 683 to set up a service call and/or order parts.

In embodiments, one or more IoT-enabled motion sensors 4656 may communicate motion sensor status and/or motion sensor measurements through a smart home/office API 647 resident within one or more memory devices 646 on one or more shading devices. In embodiments, a smart home server 670 may receive communicated motion sensor status and/or motion sensor measurements and analyze status and/or measurements to identify when and/or where motion has been detected in the area around the smart home and/or office. In embodiments, for example, in response to motion detection measurements, a smart home server 670 may communicate signals, messages, instructions and/or commands to other assemblies 680 connected via IoT to a smart home. For example, a smart home server may communicate a message and/or command to one or more lighting assemblies in a smart home in an area where a shading device motion sensor has detected movement. Similarly, in embodiments, a smart home server may communicate a message and/or instruction to an audio receiver and/or speaker 680 to emit an alarm and/or spoken phrase in an area where motion has been detected. In some embodiments, a smart home server 670 may communicate a message, instruction, and/or messages to one or more shading devices via a smart home API 647 to initiate and/or activate one or more cameras to capture video, images and/or audio from an area where motion has been detected. In such embodiments, for example, one or more cameras may transmit and/or communicate video, audio and/or images to a smart home server via a smart home API. In embodiments, a smart home server 670 may communicate received images, video and/or audio to a home or office security system or computing device 683 for monitoring by security personnel or residents of a smart home, office and/or building. In some embodiments, received images, video and/or audio may be stored in one or more memory devices 671 of a smart home server 670. In some embodiments, a smart home server 670 may be located within a smart home or office, or may be located in a remote and/or third-party location (e.g., a cloud-based server).

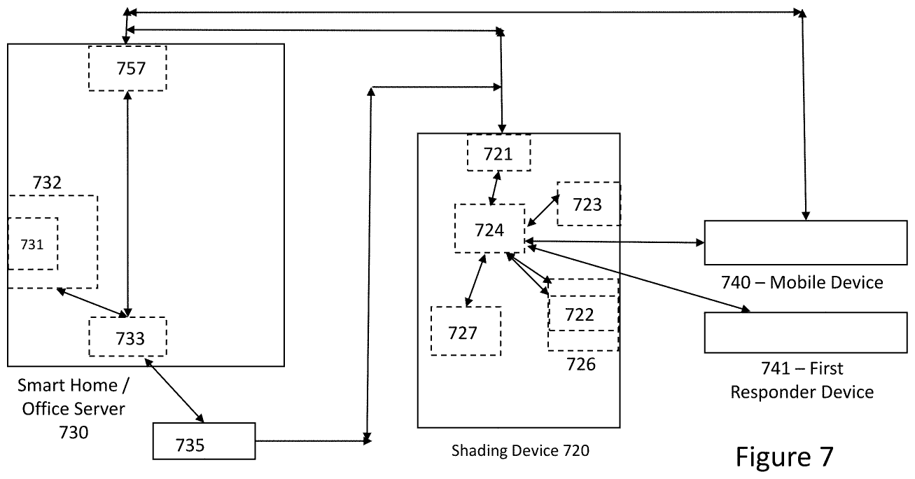

FIG. 7 illustrates a smart home, smart office or smart building IoT-enabled server communicating and transferring information to a modular umbrella shading system according to embodiments. In embodiments, a smart home, office and/or building IoT-enabled server 730 may also communicate with an IoT-enabled shading device 720 and/or one or more IoT-enabled devices within one or more shading device 720. For example, in embodiments, a smart home, office or building server and/or computing device 730 software application (e.g., computer-readable instructions 731 stored in one or more memory modules 732 executable by one or more processors 733) may communicate audio files or streams, video files or streams, executable software files, software updates and/or revisions, and/or alarm/emergency conditions to one or more shading devices 720. For example, a smart home or office server or computing device 730 and/or software application may receive a selection from a user to play a specific digital music playlist from a the smart home or smart office server 730 or a third party cloud-based server (e.g., such as iTunes) or a digital music repository 735. In embodiments, digital and/or audio files may be communicated and/or transferred from a third-party cloud-based server and/or from a smart home server to one or more shading devices 720 via a transceiver 721 (and/or smart home application programming interface (API) or digital music API 722). In embodiments, one or more processors 724 may communicate audio and/or video files to an audio receiver and/or speaker 823. In embodiments, one or more shading devices 720 audio receiver and/or speaker 723 may reproduce sound communicated and/or streamed in digital and/or analog audio from a smart home server 730 and/or cloud-based server 735. In some embodiments, video files and/or images files may also be communicated to one or more shading devices 720 and presented on a display and/or monitor of one or more shading devices 720.

In some embodiments, a smart home, office and/or building server 730 and/or application software stored in one or more memory devices 732 may transfer and/or communicate software updates and/or revisions to a computing device, a circuit board, a microcontroller, a processor and/or electronic computer assemblies 727 in a shading device 720. In embodiments, the software revisions and/or updates may be communicated via a smart home, office or building API 722 resident in one or more memory devices 726 of a shading device 720.

In some embodiments, one or more shading device 720 may also be an additional node of a smart, office or building that may be utilized to communicate with emergency service providers and/or first responders in case of emergency. For example, in embodiments, if a smart home, office or building API 722 does not receive communications and/or messages from a smart home server 730 for a predetermined period of time (e.g., one minute, 30 minutes, and/or one hour), a smart home, office and/or building API 722 may generate a message to be communicated to a mobile communication device 740 associated with an owner or dweller of a smart home, office or building. In embodiments, a smart home API 722 may utilize whichever shading device transceiver 721 may still be operational, e.g., (utilize one or more of a cellular transceiver, a PAN transceiver and/or a local area network (WiFi or 802.11) transceiver 721 to communicate message). In embodiments, if a mobile computing device 740 of an owner and/or dweller does not respond to the smart home, office or building API 722 (and/or processor 724) within a predetermined period of time, a smart home, office or building API 722 (and/or processor 724) may transmit and/or communicate an alert message to an internal or third party security server (or computing device) and/or emergency service provider servers and/or computing devices (e.g., police department, or fire department) 741 in order to notify of a potential emergency situation. In some embodiments, an emergency and/or crime may be occurring in a certain area of a home and a certain part of a smart home or smart office system may not be accessible. For example, a robbery may be occurring and a user may not want to utilize devices inside an office or residence to communicate with emergency service personnel. In these situations, for example, a user may communicate with a smart home server 730 (utilizing a mobile computing device, a remote device, and/or other electronic devices 740) which may communicate with a smart home, office or building API 722 in a shading device 720 and request a message and/or command be communicated to an emergency service provider via a cellular transceiver, a local area network wireless (WiFi) transceiver, and/or a PAN transceiver. Further, a user may communicate with a smart home/office API 722 in a modular umbrella shading system to turn on and/or activate components and/or assemblies 727 of one or more shading devices 720 (e.g., a speaker may be activated and/or utilized to generate an alarm; a lighting system may be activated to surprise or startle an intruder; a camera may be activated to capture videos from an outside of an office, home or building).

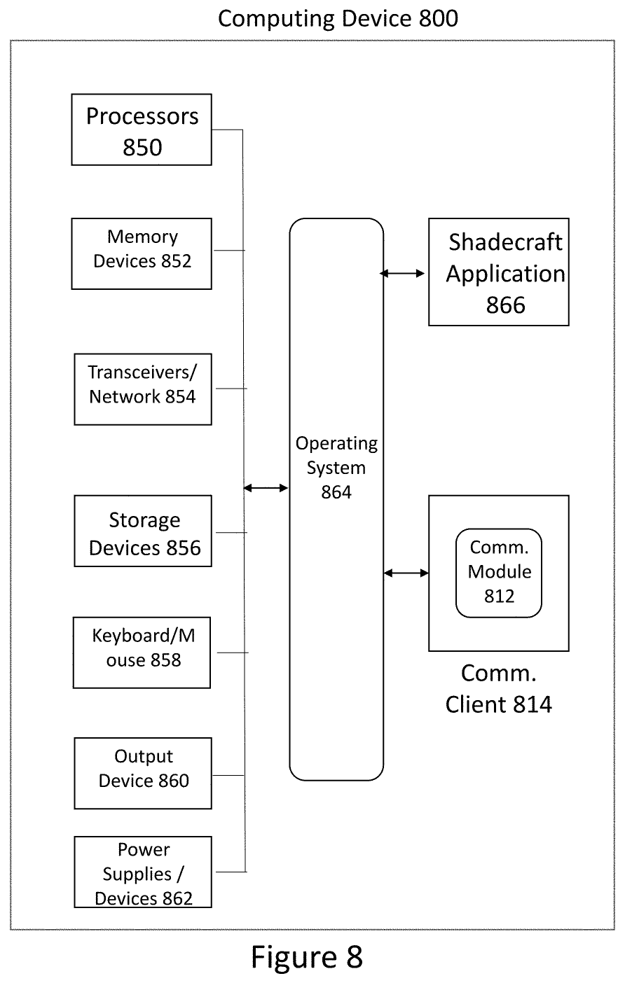

FIG. 8 illustrates a computing device according to embodiments. The computing devices described in FIG. 8 may be computing devices inside of shading devices, routing devices or routing computing devices, cellular towers or cellular shading devices, desktop computing devices, laptop computing devices, mobile computing devices, and/or tablet computing devices. The computing devices may also be server computing devices and/or cloud computing devices. In other words, some or all of the components described with respect to FIG. 8 may be in any of the devices (e.g., computing devices) listed in the Figures of this application (e.g., such as FIG. 5A, 2B, etc.). As shown in the specific example of FIG. 8, computing device 800 may include one or more processors 850, one or more memory devices 852, one or more communication transceivers or communication network interfaces 854, one or more storage devices 856, one or more input devices 858, one or more output devices 860, and one or more power sources 862. In some embodiments, mobile communications device or computing device 800 may also include one or more operating systems 864 that are executable by the mobile communications device or computing device 800. In some embodiments, mobile communications device or computing device 800, in one example, may further include shading device client software; shading device server software, and/or shading device cloud-based software 812. In some embodiments, the shading device client software; shading device server software, and/or shading device cloud-based software may be also be executable by one or more processors 850 of the mobile communications device or computing device 800. In some embodiments, each of components or assemblies 850, 852, 854, 856, 858, 860, 862, 864, 866, and 812 may be interconnected (physically, communicatively, or operatively) for inter-component communications.

In some embodiments, one or more processors 850, in one example, are configured to at least implement functionality or process instructions for execution within the computing device or mobile communications device 800. For example, one or more processors 850 may be capable of processing instructions stored in one or more memory devices 852 or instructions stored on one or more storage devices 56.

In some embodiments, one or more memory devices 852, in one example, may be configured to store information within mobile communications device or computing device 800 during operation. One or more memory devices 852, in some examples, may be described as a computer-readable storage medium. In some examples, one or more memory devices 852 may be used as a temporary memory, although one or more memory devices 852 may be used as long-term storage. In some embodiments, one or more memory devices 852, in some examples, may be described as a volatile memory, meaning that one or more memory devices 852 does not maintain stored contents when mobile communications device or computing device 800 is powered off. Examples of volatile memories include random access memories (RAM), dynamic random access memories (DRAM), static random access memories (SRAM), and other forms of volatile memories known in the art. In some examples, one or more memory devices 852 may be used to store program instructions for execution by one or more processors 850. In some embodiments, one or more memory devices 852, in one example, may be used by software or applications running on mobile communications device or computing device 800 (e.g., application 866 and/or one or more other applications 814) to temporarily store information during program execution.

In embodiments, storage devices 856, in some examples, may also include one or more computer-readable storage media. In embodiments, storage devices 856 may be configured to store large amounts of information. In embodiments, storage devices 856 may further be configured for long-term storage of information. In some examples, storage devices 856 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Mobile communications device or computing device 800, in some examples, also includes one or more transceivers or communication network interfaces 854. In some embodiments, these transceivers may be wireless communication transceivers (e.g., personal area network transceivers (PAN), wireless LAN or WiFi, and/or cellular communications transceivers. In some embodiments, the communication network invoices may be Ethernet communication interfaces, Firewire communication interfaces, and/or serial communication interfaces. Mobile communications device or computing device 800 in one example, utilizes transceiver or communication network interfaces 854 to communicate with external devices via one or more networks, such as one or more wireless networks and/or wired networks. One or more transceiver or network interfaces 854 may be a network interface card, such as an Ethernet card, an optical transceiver, a radio frequency transceiver, or any other type of device that can send and receive information. Other examples of such network interfaces and/or transceivers may include Bluetooth, 3G, 4G, 5G and/or WiFi radios in mobile computing devices or computing devices, as well as USB. In some examples, mobile communications device or computing device 800 utilizes one or more communication and network interfaces 854 to wirelessly communicate with an external device such as a server device or server computing device, a mobile phone, or other networked computing devices, as described herein.

Mobile communications device or computing device 800, in one example, also includes one or more input devices 858. Input devices 858, in some examples, are configured to receive input from a user through tactile, audio, or video input (and/or gesture recognition). Examples of input devices 858 may include a presence-sensitive screen, a mouse, a keyboard, a voice responsive system, video camera, microphone or any other type of device for detecting a command from a user. In some examples, a presence-sensitive screen includes a touch-sensitive screen. In embodiments, one or more output devices 860 may also be included in mobile communications device or computing device 800. In embodiments, output device 860, in some examples, may be configured to provide output to a user using tactile, audio, or video output. Output devices 860, in one example, may include a presence-sensitive screen or a touch screen. In embodiments, output devices 860 may utilize a sound card, a video graphics adapter card, or any other type of device for converting a signal into an appropriate form understandable to humans or machines. In embodiments, additional examples of output devices 860 may include a speaker, a cathode ray tube (CRT) monitor, a liquid crystal display (LCD), or any other type of device that can generate intelligible output to a user.

In embodiments, mobile communications device or computing device 800, in some examples, may include one or more power sources or power supplies 862, which may be rechargeable and provide power to mobile communications device or computing device 800. In embodiments, the one or more power sources or power supplies 862 may be one or more batteries. In embodiments, the one or more batteries may be made from nickel-cadmium, lithium-ion, or any other suitable material. In some embodiments, the power supplies may be switching power supplies or power supplies for server computing devices, router computing devices, and/or cloud computing devices. In another example, in embodiments, the one or more power sources or power supplies 862 may include a power supply connection that receives power from a power source external to mobile communications device or computing device 800. The one or more power sources or power supplies 862 may provide less power to communication client when the virtual communication session is in an inactive, or ambient state, than when the virtual communication session is in an active state than when it is in an inactive state.

In some embodiments, one or more application software packages or modules 866 may provide mobile communications device or computing device 800 with additional functionality. In some embodiments, an application software package may include a shading device client software; shading device server software, and/or shading device cloud-based software. In embodiments, this additional functionality may include, for example, a shading device mobile application, shading device application software, shading device client-server software and/or shading device cloud-based software, web browsing, calendar, contacts, games, document processing, or any other functionality performed by a computing device such as mobile communications device or computing device 800. In embodiments, one or more software application packages 866 may cause at least one of output devices 860 to display some elements of a graphical user interface (GUI). In embodiments, mobile communications device or computing device 800 may include one or more operating systems 864. Operating systems 864, in some examples, may control the operation of components of mobile communications device or computing device 800. For example, operating system 864, in one example, may facilitate the interaction of communication client 812 with processors 850, memory device 852, communication transceivers or network interfaces 854, storage devices 856, input devices 858, output devices 860, and power sources or power supplies 862. In some embodiments, communication client 812 may include communication module 814. In some embodiments, one or more software applications 866 (including the various shading device software applications described above), communications client 812, and communication module 814 may each include at least one of computer-readable program instructions or data that are executable by one or more processors 850 of a mobile communications device or computing device 800. For example, in embodiments, communication module 814 may include computer-readable instructions executable by one or more processors 850 that cause communication client 812 to perform one or more of the operations and actions described in the present disclosure.

In some examples, in embodiments, at least one of application software packages 866, communication client 812, or communication module 814 may be a part of one or more operating systems 864 operating and being executed by one or more processors 850 of a mobile communications device or computing device 800. In some examples, in embodiments, communication client 812 may receive input from one or more input devices 858 of mobile communications device or computing device 800. In embodiments, communication client 812 may, for example, receive at least one of audio or video information associated with a communication session from other computing devices participating in the communication session.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data from a camera or imaging device, transform the image data, output a result of the transformation to communicate to external local and remote computing devices, and store the result of the transformation in one or more memory devices. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

The above disclosure is sufficient to enable one of ordinary skill in the art to practice the invention and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

The above disclosure is sufficient to enable one of ordinary skill in the art to practice the invention and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A computing device, comprising:
one or more memory devices;
one or more processors;
computer-readable instructions stored in the one or more memory devices, the computer-readable instructions being accessible from the one or more memory devices and executable by the one or more processors to:
receive first parameters or first measurements and associated first shading device identifiers from components or assemblies of one or more first shading devices via a mobile communications device;
receive shading commands, instructions or messages from an artificial intelligence or voice recognition computing device;
communicate shading device commands, instructions or messages to one or more second shading devices via a routing computing device or a cellular computing device; and
receive second parameters or second measurements and associated second shading device identifiers from the routing computing device or the cellular computing device.

2. The computing device of claim 1, wherein the routing computing device communicates with the one or more second shading devices via a wireless local area network.

3. The computing device of claim 1, wherein the cellular computing device communicates with the one or more second shading devices via a cellular communications network.

4. The computing device of claim 1, wherein the mobile communication device communicates with the one or more first shading devices via a Bluetooth Low Energy (BLE) communications protocol.

5. The computing device of claim 1, further comprising computer-readable instructions executable by the one or more processors to communicate shading device commands to a master shading device having a wireless communication transceiver, the master shading device to communicate the shading device commands, instructions or messages to one or more third shading devices and to receive third parameters or third measurements and associated third shading device identifiers from the one or more third shading devices.

6. The computing device of claim 5, wherein the master shading device communicates with the one or more third shading devices via a wireless local area network.

7. The computing device of claim 1, further comprising computer-readable instructions executable by the one or more processors to store the first parameters or first measurements and the associated first identifiers and the second parameters or second parameters and the associated second identifiers in a database in the one or more memory devices.

8. The computing device of claim 7, further comprising computer-readable instructions executable by the one or more processors to analyze the first parameters or the first measurements and the associated first identifiers and the second parameters or the second measurements and the associated second identifiers to detect trends.

9. The computing devices of claim 8, further comprising computer-readable instructions executable by the one or more processors to communicate responsive commands, instructions or messages to the one or more first shading devices or the one or more second shading devices, the responsive commands, instructions or messages based, at least in part, on the detected trends.

10. A computing device, comprising:
one or more memory devices;
one or more processors;
computer-readable instructions stored in the one or more memory devices, the computer-readable instructions being accessible from the one or more memory devices and executable by the one or more processors to:
receive first parameters or first measurements and associated first shading device identifiers from components or assemblies of one or more first shading devices via a mobile communications device;
receive shading commands, instructions or messages from a user computing device that has an account on the computing device;
communicate shading device commands, instructions or messages to one or more second shading devices via a routing computing device or a cellular computing device; and
receive second parameters or second measurements and associated second shading device identifiers from the routing computing device or the cellular computing device.

11. The computing device of claim 10, wherein the routing computing device communicates with the one or more second shading devices via a wireless local area network.

12. The computing device of claim 10, wherein the cellular computing device communicates with the one or more second shading devices via a cellular communications network.

13. The computing device of claim 10, wherein the mobile communication device communicates with the one or more first shading devices via a Bluetooth Low Energy (BLE) communications protocol.

14. The computing device of claim 10, further comprising computer-readable instructions executable by the one or more processors to communicate shading device commands to a master shading device having a wireless communication transceiver, the master shading device to communicate the shading device commands, instructions or messages to one or more third shading devices and to receive third parameters or third measurements and associated third shading device identifiers from the one or more third shading devices.

15. The computing device of claim 14, wherein the master shading device communicates with the one or more third shading devices via a wireless local area network.

16. The computing device of claim 10, further comprising computer-readable instructions executable by the one or more processors to store the first parameters or first measurements and the associated first identifiers and the second parameters or second parameters and the associated second identifiers in a database in the one or more memory devices.

17. The computing device of claim 16, further comprising computer-readable instructions executable by the one or more processors to analyze the first parameters or the first measurements and the associated first identifiers and the second parameters or the second measurements and the associated second identifiers to detect trends.

18. The computing devices of claim 17, further comprising computer-readable instructions executable by the one or more processors to communicate responsive commands, instructions or messages to the one or more first shading devices or the one or more second shading devices, the responsive commands, instructions or messages based, at least in part, on the detected trends.
